(19) United States
(12) Patent Application Publication
(10) Pub. No.: US 2025/0234288 A1
(43) Pub. Date: Jul. 17, 2025

(54) DYNAMIC POWER SAVING OPERATION

(71) Applicant: Samsung Electronics Co., Ltd., Suwon-si (KR)

(72) Inventors: Vishnu Vardhan Ratnam, Plano, TX (US); Bilal Sadiq, Frisco, TX (US); Boon Loong Ng, Plano, TX (US); Rubayet Shafin, Allen, TX (US); Peshal Nayak, Plano, TX (US); Yue Qi, Plano, TX (US)

(21) Appl. No.: 19/007,370

(22) Filed: Dec. 31, 2024

Related U.S. Application Data
(60) Provisional application No. 63/620,058, filed on Jan. 11, 2024.
(60) Provisional application No. 63/627,518, filed on Jan. 31, 2024.
(60) Provisional application No. 63/640,614, filed on Apr. 30, 2024.

(51) Int. Cl. H04W 52/02; H04L 1/00

(52) U.S. Cl. CPC H04W 52/0206; H04L 1/0009; H04L 1/003

(57) ABSTRACT

An access point (AP) in a wireless network that operates in different operating modes to save power, including a dynamic power saving (DPS) mode where the AP operates with a reduced operating parameter set or with an enhanced operating parameter set, the operating parameters include a bandwidth, number of spatial streams (NSS), and modulation coding scheme (MCS).

### CROSS-REFERENCE TO RELATED APPLICATION(S)

This application claims the benefit of priority from U.S. Provisional Application No. 63/620,058, entitled “Dynamic Power Saving Operation at an AP” filed Jan. 11, 2024; U.S. Provisional Application No. 63/627,518, entitled “Dynamic Power Saving Operation at An AP” filed Jan. 31, 2024; and U.S. Provisional Application No. 63/640,614, entitled “Dynamic Power Saving Operation at An AP” filed Apr. 30, 2024, all of which are incorporated herein by reference in their entireties.

### TECHNICAL FIELD

This disclosure relates generally to a wireless communication system, and more particularly to, for example, but not limited to, dynamic power saving (DPS) operations in a wireless network.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput. The description set forth in the background section should not be assumed to be prior art merely because it is set forth in the background section. The background section may describe aspects or embodiments of the present disclosure.

### SUMMARY

One aspect of the present disclosure provides an access point (AP) in a wireless network, comprising a memory; and a processor coupled to the memory. The processor is configured to transmit, to one or more stations (STAs), a first frame indicating that the AP supports an operation in a dynamic power saving mode. The processor is configured to transmit, to the one or more STAs, a second frame indicating a transition into the dynamic power saving mode. The processor is configured to operate in the dynamic power save mode and follow associated procedures. The processor is configured to transmit, to the one or more STAs, a third frame indicating a transition out of the dynamic power saving mode.

In some embodiments, the first frame includes at least one of: i) a maximum time that the AP requires to switch from a reduced operating parameter set to an enhanced operating parameter set associated with dynamic power saving mode, ii) a maximum time that the AP requires to switch from the enhanced operating parameter set to the reduced operating parameter set associated with dynamic power saving mode, or iii) an indication of whether the AP requires medium protection while the AP transitions from the enhanced operating parameter set to the reduced operating parameter set associated with dynamic power saving mode.

In some embodiments, the second frame includes at least one of: an indication of the AP transition into the dynamic power saving mode; an indication of a start time for the transition to the dynamic power saving mode; an indication of a reduced operating parameter set associated with the dynamic power saving mode; an indication of one or more enhanced operating parameter sets associated with the dynamic power saving mode; an indication of a maximum time that the AP requires to switch from the reduced operating parameter set to the one or more enhanced operating parameter sets associated with dynamic power saving mode; an indication of a maximum time that the AP requires to switch from the one or more enhanced operating parameter sets to the reduced operating parameter set associated with dynamic power saving mode; or an indication of whether the AP requires medium protection while the AP transitions from the one or more enhanced operating parameter sets to the reduced operating parameter set associated with dynamic power saving mode.

In some embodiments, the AP operates with a reduced operating parameter set in the dynamic power saving mode by default, where the reduced operating parameter set includes a reduction of at least one of a maximum supported channel width, a supported set of modulation and coding schemes, a maximum supported number of spatial streams, or supported physical layer version formats for either transmission or reception at the AP.

In some embodiments the processor is further configured to: receive, from at least one STA in the one or more STAs, a fourth frame that requests a transition to an enhanced operating parameter set; and transition to the enhanced operating parameter set, wherein the enhanced operating parameter set includes at least one of an enhanced maximum supported channel width, channel numbers corresponding to the enhanced maximum channel width, enhanced set of and modulation coding schemes, an increased maximum supported number of spatial streams, or an increased set of supported physical layer version formats.

In some embodiments, the processor is further configured to operate with the enhanced operating parameter set associated with the dynamic power save mode for a duration of a transmission opportunity (TXOP) corresponding to the fourth frame, and switch back to a reduced operating parameter set associated with the dynamic power saving mode at a time determined by the end of the TXOP.

In some embodiments, the processor is further configured to periodically transmit a fifth frame indicating dynamic power saving parameters including one or more of: an indication of the AP operating in the dynamic power saving mode; an indication of one or more enhanced operating parameter set associated with the dynamic power saving mode; an indication of a reduced operating parameter set associated with the dynamic power saving mode; or an indication of the AP operating with an enhanced operating parameter set for a given duration after the indication.

In some embodiments, the processor is further configured to transmit, before operating in the dynamic power saving mode, a sixth frame to the one or more STAs that indicates a change in the AP's transmission and reception capabilities, where the capabilities are determined based on the reduced operating parameter set associated with the dynamic power saving mode.

In some embodiments, the processor is further configured to: receive, from at least one STA in the one or more STAs, a seventh frame that indicates a capability of sending a request frame to the AP to transition to an enhanced operating parameter set associated with the dynamic power saving mode.

In some embodiments the third frame includes at least one of: an indication that the AP is transitioning out of the dynamic power saving mode; or an indication of a time when the AP transitions out of the dynamic power saving mode.

One aspect of the present disclosure provides a station (STA) in a wireless network, comprising: a memory; and a processor coupled to the memory. The processor is configured to: receive, from an access point (AP), a first frame indicating that the AP supports an operation in a dynamic power saving mode. The processor is configured to receive, from the AP, a second frame indicating a transition into the dynamic power saving mode. The processor is configured to while the AP is operating in dynamic power save mode, follow associated procedures.

In some embodiments, the first frame includes at least one of: i) a maximum time that the AP requires to switch from a reduced operating parameter set to an enhanced operating parameter set associated with the dynamic power saving mode, ii) a maximum time that the AP requires to switch from the enhanced operating parameter set to the reduced operating parameter set associated with the dynamic power saving mode, or iii) an indication of whether the AP requires medium protection while the AP transitions from the enhanced operating parameter set to the reduced operating parameter set associated with the dynamic power saving mode.

In some embodiments, the second frame includes at least one of: an indication of the AP transition into the dynamic power saving mode; an indication of a start time for the transition to the dynamic power saving mode; an indication of a reduced operating parameter set associated with the dynamic power saving mode; an indication of one or more enhanced operating parameter sets associated with the dynamic power saving mode; an indication of a maximum time that the AP requires to switch from the reduced operating parameter set to the one or more enhanced operating parameter sets associated with dynamic power saving mode; an indication of a maximum time that the AP requires to switch from the one or more enhanced operating parameter sets to the reduced operating parameter set associated with dynamic power saving mode; or an indication of whether the AP requires medium protection while the AP transitions from the one or more enhanced operating parameter sets to the reduced operating parameter set associated with dynamic power saving mode.

In some embodiments, the AP operates with a reduced operating parameter set in the dynamic power saving mode by default, wherein the reduced operating parameter set includes a reduction of at least one of a maximum supported channel width, a supported modulation coding schemes, a maximum supported number of spatial streams, or supported physical layer version formats for either transmission or reception at the AP.

In some embodiments, wherein the AP operates with one or more enhanced operating parameter sets, wherein the one or more enhanced operating parameter sets includes at least one of an enhanced maximum channel width, channel numbers corresponding to the enhanced maximum supported channel width, enhanced modulation coding scheme, an increased maximum supported number of spatial streams, or an increased set of supported physical layer version formats.

In some embodiments, after winning a transmit opportunity, the processor is configured to determine if the AP is operating with either an enhanced operating parameter set or a reduced operating parameter set and based on the determination, either: transmit to the AP frames that are compliant with the enhanced operating parameter set of the AP, or transmit to the AP frames that are compliant with the reduced operating parameter set of the AP, or transmit to the AP a third frame that requests the AP to transition to an enhanced operating parameter set and transmit subsequent frames that are compliant with the enhanced operating parameter set for the duration of the transmit opportunity.

In some embodiments, the processor is further configured to: transmit, to the AP, a fourth frame that indicates a capability of sending a request frame to the AP to transition to an enhanced operating parameter set associated with the dynamic power saving mode.

One aspect of the present disclosure provides a computer-implemented method for wireless communication by an access point (AP) in a wireless network. The method comprises transmitting, to one or more stations (STAs), a first frame indicating that the AP supports an operation in a dynamic power saving mode. The method comprises transmitting, to the one or more STAs, a second frame indicating a transition into the dynamic power saving mode. The method comprises operating in the dynamic power save mode and follow associated procedures. The method comprises transmitting, to the one or more STAs, a third frame indicating a transition out of the dynamic power saving mode.

In some embodiments, the first frame includes at least one of: i) a maximum time that the AP requires to switch from a reduced operating parameter set to an enhanced operating parameter set associated with dynamic power saving mode, ii) a maximum time that the AP requires to switch from the enhanced operating parameter set to the reduced operating parameter set associated with dynamic power saving mode, or iii) an indication of whether the AP requires medium protection while the AP transitions from the enhanced operating parameter set to the reduced operating parameter set associated with dynamic power saving mode.

In some embodiments, the second frame includes at least one of: an indication of the AP transition into the dynamic power saving mode; an indication of a start time for the transition to the dynamic power saving mode; an indication of a reduced operating parameter set associated with the dynamic power saving mode; an indication of one or more enhanced operating parameter sets associated with the dynamic power saving mode; an indication of a maximum time that the AP requires to switch from the reduced operating parameter set to the one or more enhanced operating parameter sets associated with dynamic power saving mode; an indication of a maximum time that the AP requires to switch from the one or more enhanced operating parameter sets to the reduced operating parameter set associated with dynamic power saving mode; or an indication of whether the AP requires medium protection while the AP transitions from the one or more enhanced operating parameter sets to the reduced operating parameter set associated with dynamic power saving mode.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4A an Operating Mode Notification Frame format in accordance with an embodiment.

FIG. 4B illustrates an Operating Mode A-control field format in accordance with an embodiment.

FIG. 5 illustrates a format of an Operation element that is transmitted by AP in accordance with an embodiment.

FIG. 6 illustrates a Capabilities element in accordance with an embodiment.

FIG. 7 illustrates an operation for a two-link non-AP MLD in accordance with an embodiment.

FIG. 8 illustrates an AP that operates a Basic Service Set (BSS) with several associated STAs in accordance with an embodiment.

FIG. 9 illustrates a capability indication in a Capabilities element in accordance with an embodiment.

FIG. 10A illustrates an example format of an enhanced operating parameters using modified coding scheme (MCS) and number of spatial streams (NSS) in accordance with an embodiment.

FIG. 10B illustrates an example format of an enhanced operating parameters using a max NSS indication in accordance with an embodiment.

FIG. 11 illustrates an example of a notification frame and a Control element in accordance with an embodiment.

FIG. 12 illustrates a Wakeup Request frame as a variant of a MU-RTS trigger frame in accordance with an embodiment.

FIG. 13 illustrates an example of protecting a medium for transition back to reduced operating parameters in accordance with an embodiment.

FIG. 14 illustrates an example of protecting a medium for transition back to reduced operating parameters in accordance with an embodiment.

FIG. 15 illustrates a flow chart of an example process performed by an AP for dynamic power save (DPS) operation in accordance with an embodiment.

FIG. 16 illustrates a flow chart of an example process performed by a non-AP STA to support an AP operating in DPS mode in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

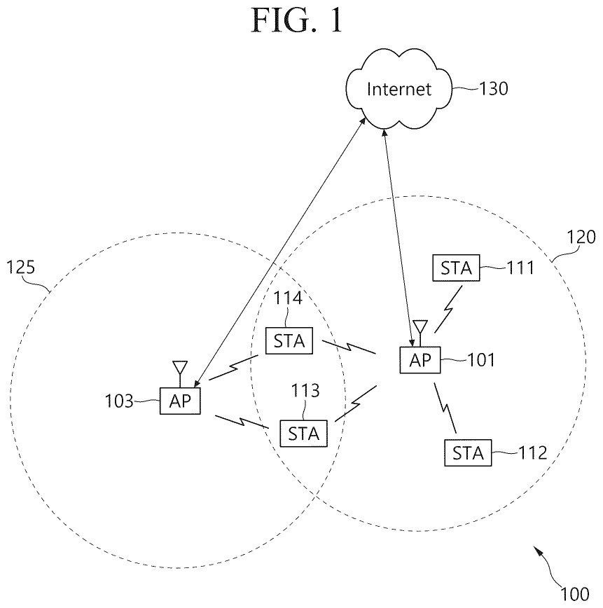

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

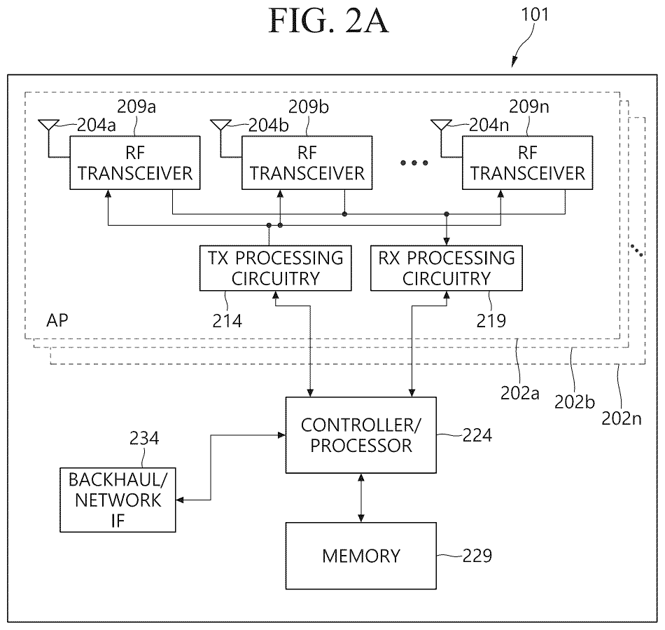

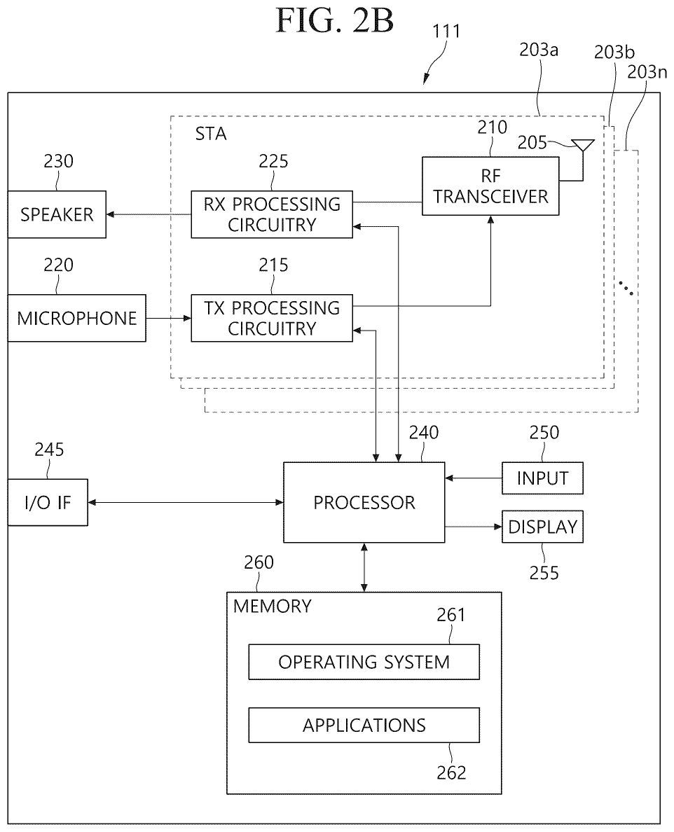

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

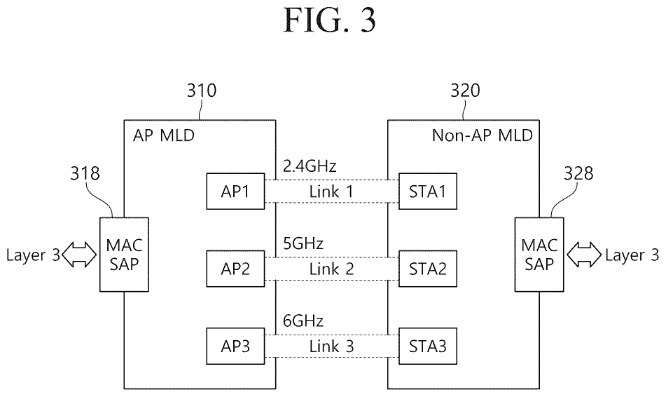

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: 1) IEEE 802.11-2020, “Wireless LAN Medium Access Control (MAC) and Physical Layer (PHY) Specifications;” 2) IEEE 802.11ax-2021, “Wireless LAN Medium Access Control (MAC) and Physical Layer (PHY) Specifications;” and 3) IEEE P802.11be/D4.0, “Wireless LAN Medium Access Control (MAC) and Physical Layer (PHY) Specifications;”

A wireless network station (STA) can be in one of two states, including an awake state and a doze state. In the awake state, the STA continuously monitors the channel and can transmit or receive packets. In the doze state, the STA does not monitor the channel, for example, for the purpose of saving power.

A non-AP STA can be in one of two power management modes, including and active mode and a power save (PS) mode. In the active mode, the STA receives and transmits frames at any time and the STA remains in the awake state. In the power save (PS) mode, the STA enters the awake state to receive or transmit frames and the STA remains in the doze state otherwise.

To allow non-AP STAs to save power, the existing standards support several power-save methods that determine how a STA behaves when in PS mode and how the STA transitions between power save mode and active mode. These include Normal power save (PS), automatic power save delivery (APSD), wireless network management (WNM) power save, Power-save multi-poll mode, Spatial multiplexing PS, IBSS power save, VHT TXOP Power Save, Target Wake Time (TWT), among others.

However, many of such power saving features may not be applicable to access points (APs). To provide power saving mechanisms for APs (and also for STAs) that are operating in awake state, the IEEE 802.11 2020 draft also defines a power saving mechanism called “operating mode change”. By using an operating mode change, a STA can change its operating channel width (CW) and/or the maximum number of spatial streams (NSS) that it can support. Thus, an STA can save power by reducing channel width or a number of spatial streams when required. An AP or non-AP STA can change its RX operating mode by either: transmitting an Operating Mode Notification frame, which may be a Very High Throughput (VHT) Action frame (class 3 management), transmitting an Operating Mode Notification element inside a beacon frame, (Re)association request/response frames, or transmitting an Operating Mode (OM) Control subfield or EHT OM Control subfield in an A-control field of a Quality of service (QoS) Data, QOS Null or Class 3 Management frames.

A non-AP STA can change its TX operating mode by either transmitting an OM Control subfield or EHT OM Control subfield in an A-control field of a QoS Data, QoS Null or Class 3 Management frames.

For any Modulation and Coding Scheme (MCS), the maximum receive NSS that a STA can support is equal to the smaller of: 1) the value of the “Rx Max Nss That Supports Specified MCS” subfield for the given EHT-MCS indicated in the Supported EHT-MCS and NSS Set or 2) the maximum supported NSS as indicated by the value of the Rx NSS field of the Operating Mode Notification frame or the Operating Mode Notification element if the value of Rx NSS Type is 0, or by the value of the Rx NSS field of the OM Control subfield if EHT OM Control subfield is not present in the same A-Control field, or by the value of the Rx NSS Extension field of the EHT OM Control subfield combined with the value of the Rx NSS field of the OM Control subfield

For any MCS, the maximum transmit NSS that a STA can support is equal to the smaller of: 1) the value of the “Tx Max Nss That Supports Specified MCS” subfield for the given EHT-MCS indicated in the Supported EHT-MCS and NSS Set or 2) the maximum supported NSS as indicated by the value of the Tx NSTS field of the OM Control subfield if EHT OM Control subfield is not present in the same A-Control field, or by the value of the Tx NSS Extension field of the EHT OM Control subfield combined with the value of the Tx NSS field of the OM Control subfield.

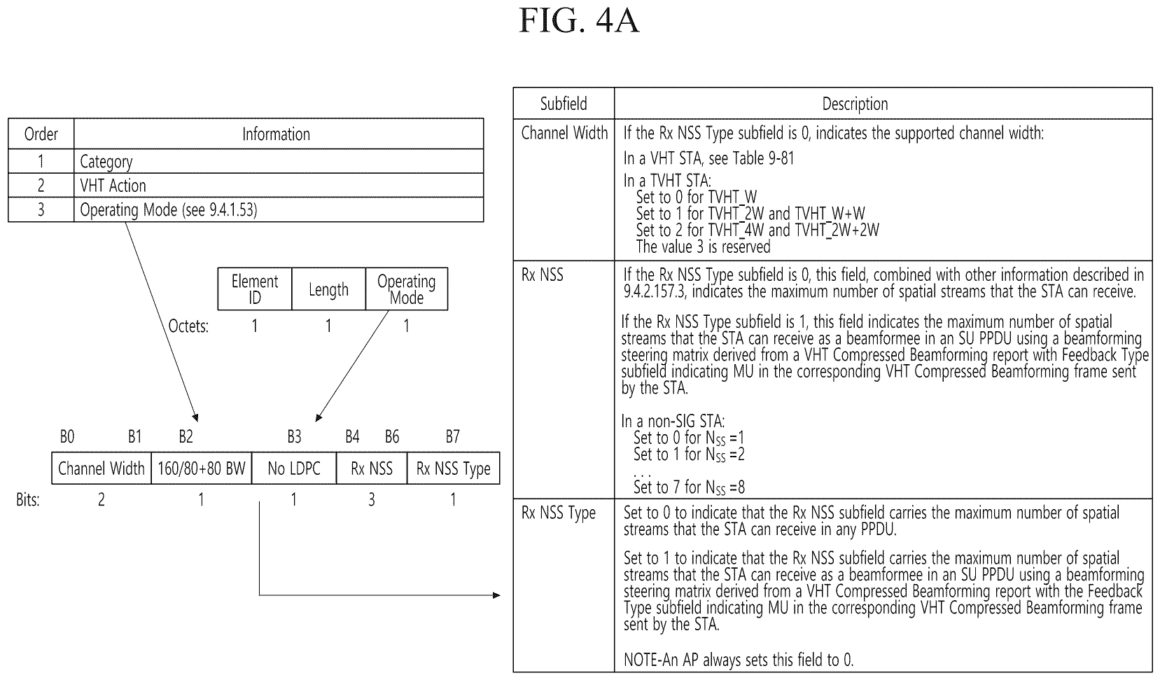

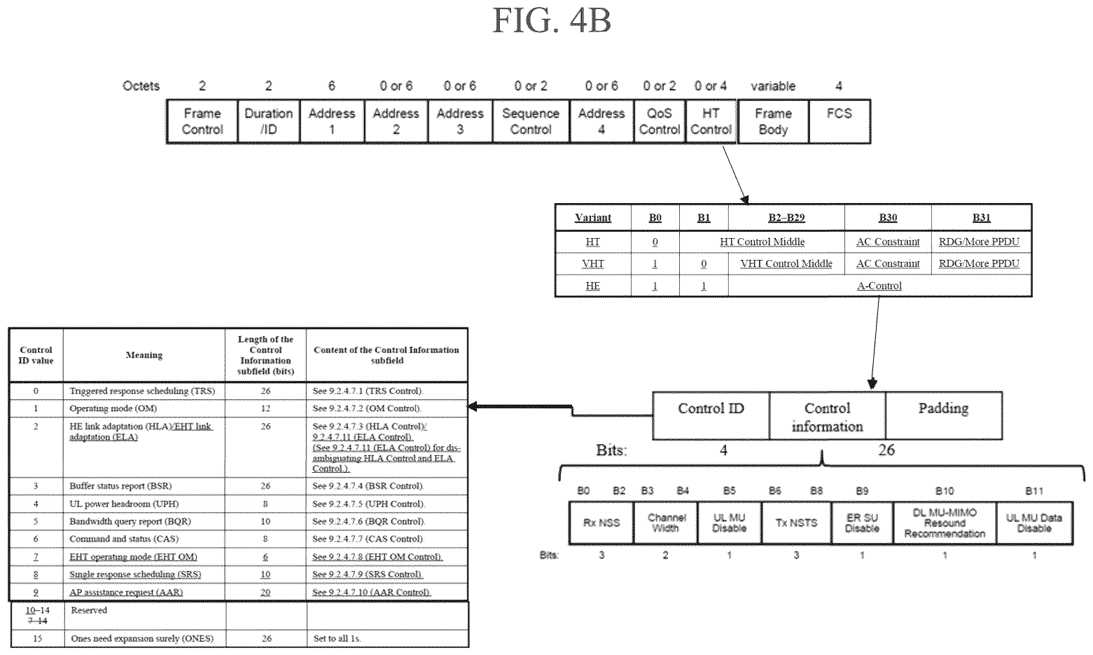

FIG. 4A and FIG. 4B illustrate an operating mode notification frame and the operating mode control field in accordance with an embodiment. In particular, FIG. 4A an Operating Mode Notification Frame format in accordance with an embodiment. FIG. 4B illustrates an Operating Mode A-control field format in accordance with an embodiment. To indicate the current operating parameters of a basic service set (BSS), the AP transmits one or more Operations elements in its beacons, probe response and association response frames. The AP uses the primary channel field of HT Operations element to indicate current primary 20 MHz channel. It also uses the Secondary Channel Offset field to indicate the location of secondary 20 MHz channel if CW>=40 MHz. The CCFS0/CCFS1 fields of VHT Operation element (or HE element if VHT is not present) indicate the location of the primary and secondary 80 MHz channels. The CCFS0/CCFS1 fields EHT Operation element indicate the primary and secondary 160 MHz channels. The STA Channel Width field of HT Operations, Channel width field of VHT Operation element, Channel width field of HE Operation element, and Channel width field of EHT Operation element to jointly indicate the operating CW of the BSS. When operating in channels where HT/VHT etc. elements are not present, these fields are replicated in HE Operation element.

For example, the operation of EHT STAs in an EHT BSS is controlled by: 1) the HT Operation element, HE Operation element, and EHT Operation element if operating in the 2.4 GHz band; 2) the HT Operation element, VHT Operation element (if present), HE Operation element, and EHT Operation element if operating in the 5 GHz band; 3) the HE Operation element and EHT Operation element if operating in the 6 GHz band, or 4) the Basic HT/VHT/HE/EHT MCS and NSS Set of the HT/VHT/HE/EHT Operations element is what all STAs in the BSS must support at the minimum for HT/VHT/HE/EHT PPDUs.

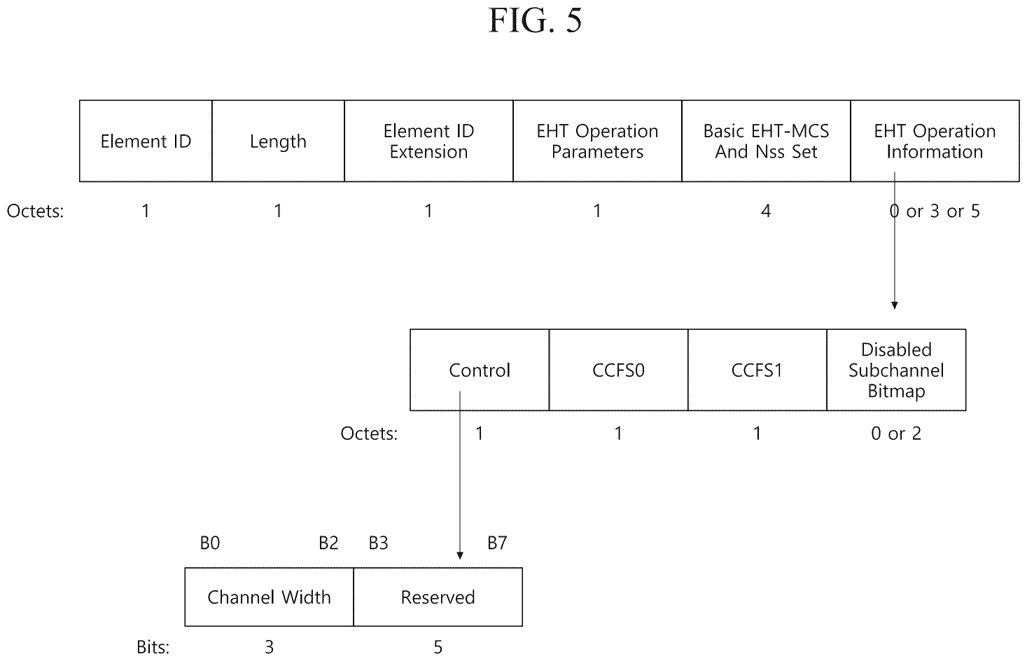

FIG. 5 illustrates a format of the EHT Operation element that is transmitted by an EHT AP in accordance with an embodiment. To indicate the different channel widths, modulation and coding schemes (MCS) and number of spatial streams (NSS) that a STA supports, each STA also transmits a Capabilities element.

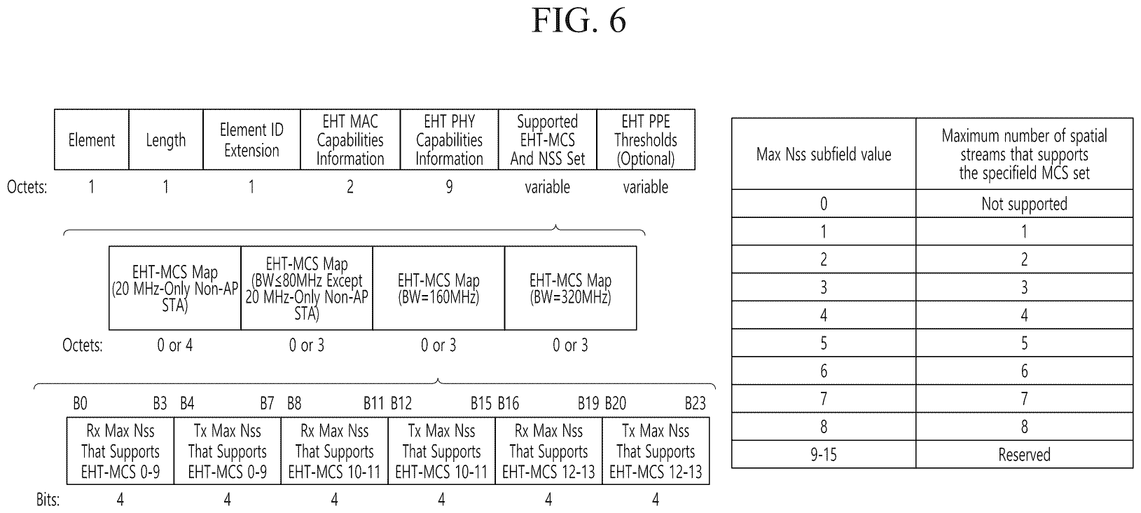

FIG. 6 illustrates an EHT Capabilities element in accordance with an embodiment. In the Supported Channel Width Set field of the Capabilities element, a STA indicates the different channel widths it supports. For an AP, this is a super set of the current BSS channel width indicated in Operations element(s). The MCS and NSS that can be supported at each CW is indicated in the Supported MCS and NSS Set field of the Capabilities element. The encoding is quite different for VHT, HE and EHT.

For HT, there is a 77-bit bitmap whose bit i is set to 1 if MCS i is supported. The values are common to all channel widths.

For VHT, the MCS that can be supported for each NSS is indicated in the range {0-7,0-8,0-9} in a 16-bit Supported MCS and NSS Set field. The values are common to all channel widths. Difference in the NSS Supported for each CW is identified from the ‘Supported Channel Width Set’+‘Extended NSS CW Support’ fields.

For HE, the MCS that can be supported for each NSS is indicated in the “Tx/Rx HE-MCS Map” subfields of the “Supported HE MCS and NSS Set” field of the HE capabilities element (similar to VHT). However, the Map is separate for each bandwidth range.

For EHT, the maximum NSS (for TX and RX respectively) for each MCS is indicated in the “EHT-MCS Map” subfield of the “Supported EHT MCS and NSS Set” field of the EHT capabilities element. Indication is separate for each MCS range {0-9,10-11,12-13} and is different for each Bandwidth.

The capabilities element is a “per link indication” and is transmitted by a non-AP STA according to the following: mandatorily carried in an Association/reassociation request frame sent by a non-AP STA; mandatorily present in a probe request frame sent by a non-AP STA; mandatorily present in a TDLS Discovery Request/Response frame.

The capabilities element is a “per link indication” and is transmitted by AP STA according to the following: mandatorily carried in a beacon frame transmitted by the AP; mandatorily carried in an Association/reassociation response frame transmitted by the AP; or mandatorily carried in a probe response frame transmitted by the AP.

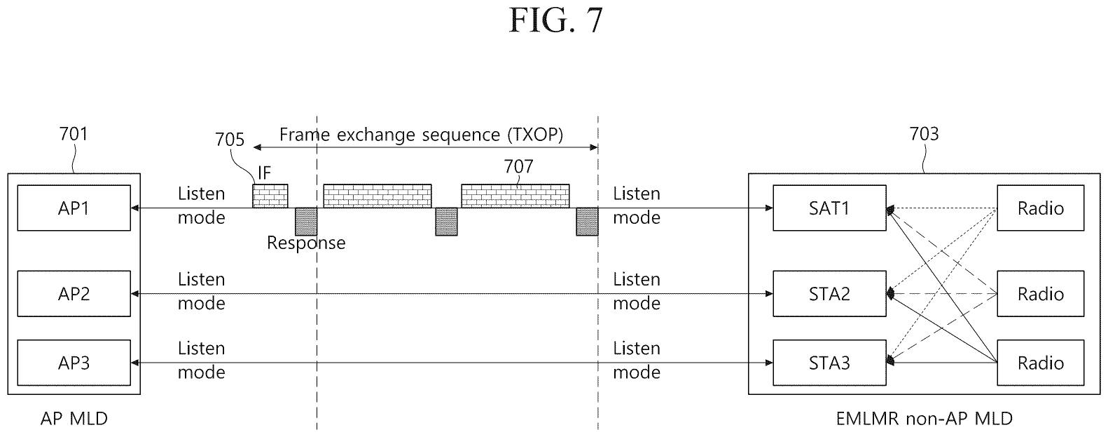

The IEEE 802.11be standard supports multiple bands of operation, where an access point (AP) and a non-AP STA can communicate with each other, called links. Thus, both the AP and non-AP STA may be capable of communicating on different bands/links, which is referred to as multi-link operation (MLO). Devices capable of MLO operation are referred to as multi-link devices (MLDs). For improving the supported MCS and NSS opportunistically and thus to improve spectral efficiency, IEEE 802.11be also supports an operating mode for a non-AP MLD device called enhanced multi-link multi-radio (EMLMR) mode. Such a device is capable of moving its radios across its links. Upon start of a frame exchange sequence with the AP on a first link, a non-AP MLD in EMLMR mode can move radios across from its other links the first link, to improve the supported MCS and NSS on that link. The set of links at an EMLMR non-AP MLD that have this capability to move radios to/from may be referred to as EMLMR links. The operating procedure for a non-AP MLD in EMLMR mode is defined in the current 802.11be standard draft and is illustrated in FIG. 7 in accordance with an embodiment.

FIG. 7 illustrates EMLMR operation for a two-link non-AP MLD in accordance with an embodiment. According to this procedure, if both the AP MLD 701 and non-AP MLD 703 support EMLMR operation, then to initiate EMLMR operation, a STA of the non-AP MLD first transmits an EML Operating Mode Notification Frame (EOMNF) 705, with the “EMLMR mode” bit set to 1 in the EML control field of the frame, to the corresponding AP affiliated with the AP MLD. The EOMNF 705 may include several parameters for the EMLMR operation including the identity of the links that can be considered for the EMLMR mode, via the EMLMR Link bitmap field. In the EML control field of EML Operating Mode Notification Frame (EOMNF), the non-AP MLD also includes an “EMLMR supported MCS and NSS Set” subfield, that indicates (via an MCS map) for each channel CW the max supported MCS and NSS combinations in EMLMR mode, that are applicable for all EMLMR links. Note that these are “enhanced” MCS and NSS values which override the values indicated in the “EHT-MCS Map” subfield of the “Supported EHT MCS and NSS Set” field of the EHT capabilities element for each of the links indicated in the EMLMR Link bitmap field of the EOMNF. To exit from an EMLMR operating mode, the non-AP MLD may transmit an EOMNF 707 with the EMLMR mode bit of the EML control field set to 0 to the AP MLD.

For improving channel access capability with limited hardware cost and power consumption or to improve spectral efficiency, IEEE 802.11be also supports an operating mode for a non-AP MLD device called enhanced multi-link single radio (EMLSR) mode. In EMLSR mode, a non-AP device behaves like a single radio device that can perform channel sensing and reception of elementary packets on multiple bands or links simultaneously (which may be referred to herein as EMLSR listen state), but can perform reliable data communication on only one link at a time. Thus, by opportunistically selecting a link for data-communication where it wins the channel contention, EMLSR can improve system spectral efficiency.

In discussions for the IEEE 802.11bn, attention has been paid towards the need to reduce the power consumption at the AP side. For this, several strategies have been discussed including scheduling periodic sleep durations for the AP, enabling cross-link AP wakeup request, enabling dynamic power saving for the AP by use of EMLSR “listen” operation, among others.

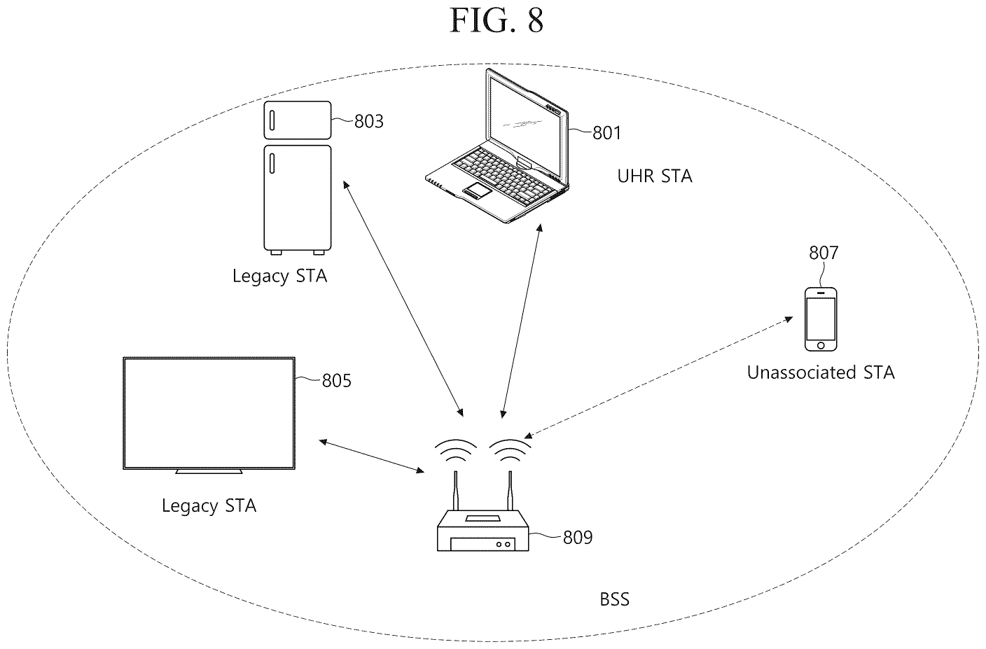

FIG. 8 illustrates a generic scenario whereby an AP operates a Basic Service Set (BSS) with several associated STAs in accordance with an embodiment. As illustrated, some of the STAs may be UHR STAs 801, and some may be legacy STAs 803 and 805. There may also be several unassociated STAs 807 which may intend to associate with the AP 809 later. Based on implementation specific reasons, the AP 809 may intend to reduce its operating parameters (such as channel width, number of spatial streams, physical protocol data unit format capability, among others) with the intent of saving power. However, while doing so, the AP may also intend to limit degradation in performance for UHR STAs 801 by being able to perform dynamic expansion of its operating parameters. As described herein, the terms “channel width” and “bandwidth” may be used interchangeably.

In some embodiments, in order to save power and yet minimize the degradation in performance for latency sensitive traffic, an AP may operate in Dynamic Power Save (DPS) mode. In DPS mode, by default, the AP may operate with reduced capabilities, e.g., one or more of reduced channel width, support for limited Physical Protocol Data Unit (PPDU) formats, a reduced MCS set and NSS set, among other capabilities. The AP may operate with reduced capabilities for reception, for transmission, or for both. Operating with reduced capabilities may enable the AP to save power. Without loss of generality, the reduced channel width, limited PPDU formats, MCS set and NSS values may be referred to herein as reduced operating parameters. The AP may indicate reduced operating parameters applied during DPS mode operation. A STA may receive this indication from the AP and communicate with the AP in accordance with the AP's indicated reduced capabilities. However, upon receiving a request within a TXOP, the AP can increase one or more of its operating parameters, including supported bandwidth (BW), supported PPDU formats, MCS set and NSS set for at least the duration of the TXOP. Without loss of generality, this channel width and MCS and NSS values may be referred to herein as the enhanced operating parameters. Thus, after sending a request to the AP to increase the capabilities of an AP, the TXOP owner can perform communication at the enhanced operating parameters, including enhanced channel width, PPDU formats, MCS and NSS values for the rest of the TXOP. After the end of the TXOP or after a predetermined amount of time from the end of the TXOP, the AP may return to its reduced operating parameters. In some embodiments, a STA that is the owner of TXOP or one monitoring the request and response during TXOP, may assume the AP will continue to remain in the enhanced operating status for at least the pre-determined amount of time. The DPS mode can also be considered as an extension of EMLSR operation for an AP or an extension of EMLMR operation for an AP and can reuse some of the same notification frames.

In some embodiments, the AP may indicate if it supports operating in DPS mode, by setting a capability bit to 1 in an element that it transmits in Beacon, Probe Response and/or Association Response frames. Otherwise, the bit may be set to 0. The bit can be referred to as, for example, the DPS Support subfield or DPS Capability subfield, and may be carried in the UHR Capabilities element.

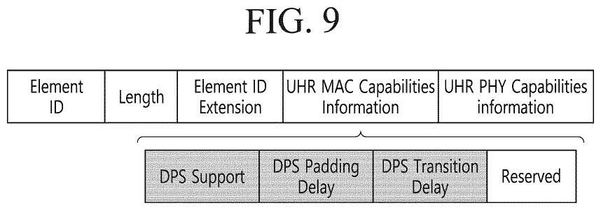

FIG. 9 illustrates a DPS capability indication in the UHR Capabilities element in accordance with an embodiment. The element includes an Element ID field, a Length field, an Element ID Extension field, a UHR MAC Capabilities Information field, a UHR PHY Capabilities Information field. The UHR MAC Capabilities Information field includes a DPS Support field, a DPS Padding Delay field, a DPS Transition Delay field, and a reserved field. The Element ID field may provide an identifier for the element. The Length field may provide length information of the element. The Element ID Extension field may provide extension information of the element. The UHR MAC Capabilities Information field may provide UHR MAC capability information. The UHR PHY Capabilities Information field may provide UHR PHY capabilities information. The DPS Support field may provide information regarding DPS support. The DPS Padding Delay field may be used by an AP to indicate the maximum time it requires to switch from the reduced operating parameters to the enhanced operating parameters, upon receiving a request to do so. The DPS Transition Delay field may be used by an AP to indicate the maximum time it requires to switch from the enhanced operating parameters to the reduced operating parameters when the switch back is required.

In some embodiments, the encoding of the delays can be, for example, similar to EMLSR Padding Delay and EMLSR Transition Delay encoding. In some embodiments, both DPS Padding Delay and DPS Transition Delay may be the same and a single field may be used for the indication. In certain embodiments, the AP may also include an indication of whether the AP requires medium protection while it transitions from enhanced operating parameters to reduced operating parameters as a TXOP responder. In some embodiments, this indication may be implicit. For example, if the DPS Transition Delay is smaller than a certain duration such as a DIFS duration, protection may not be needed.

In some embodiments, a non-AP STA can indicate if it is capable of sending a request frame to an AP operating in DPS to transition to the enhanced capabilities. In some embodiments, the STA may set a capability bit to 1 in an element that it transmits in Probe Request and/or Association Request frames to indicate to the AP that it is capable of sending a request to the AP to transition to enhanced capabilities. Otherwise, the bit may be set to 0. In some embodiments, the indication can be carried in the UHR Capabilities element. The bit can be, for example, the same as the DPS Support subfield. In some embodiments, the DPS Support subfield may be reserved for a non-AP STA. In certain embodiments that involve multi-link operation, the DPS Support may be common for all the STAs associated with an MLD and correspondingly the DPS support parameters may be indicated in the Common Info field of the Basic Multi-link element transmitted by the MLD. In some embodiments, the DPS support parameters may be included in the Per-STA profile sub-element of the Basic Multi-link element.

In some embodiments, when an AP is not operating in DPS mode, if an associated STA doesn't require the AP to operate with enhanced operating parameters to meet its QoS requirements, it can provide an indication of the same to the AP by transmitting an indication message to the AP. The message may also be solicited by the AP via a trigger frame, and the STA may send it as a response. In the trigger, the AP may also indicate the reduced operating parameters it intends to use among various other information.

In some embodiments, the response message from the STA may be in the A-control field of a QoS frame. Such indications from multiple STAs may be used by an AP to determine if it should transition to DPS mode.

In some embodiments, when an AP is operating in DPS mode, if an associated STA requires the AP to operate without DPS mode to meet its quality of service (QoS) requirements, then the STA may send an initial frame to the AP, which may also carry a request to the AP to disable of DPS mode.

Embodiments in accordance with this disclosure may provide an indication of the reduced operating parameters. In some embodiments, at least before switching to DPS mode, the AP may indicate Reduced Operating Parameters applied during DPS mode operation, e.g., one or more of reduced channel width, restricted PPDU formats, MCS set and NSS, applied to reception, transmission or both. In some embodiments, the AP may provide the indication of the reduced operating parameters before switching to DPS mode using existing mechanisms. To do so, an AP may broadcast a reduction in its operating channel width by including the Channel Switch Announcement element, Extended Channel Switch Announcement element or Operating Mode element in beacon frames, probe response and association response frames that it transmits. An AP may also use a broadcast Channel Switch Announcement frame, Extended Channel Switch Announcement frame, Operating Mode Notification frame for such indication. An AP may also provide the indication in the OM Control subfield of a QoS Data, QoS Null or Class 3 management frame that it transmits. An AP may broadcast a reduction in its RX NSS by including an Operating Mode element in beacon frames, probe response and association response frames that it transmits. An AP may also use a broadcast Operating Mode Notification frame for such indication. An AP may also provide the indication in the OM Control subfield of a QoS Data, QoS Null or Class 3 management frame that it transmits.

In some embodiments, the reduced values of the supported Channel Width and the reduced values of MCS and NSS Sets may also be broadcast by the AP in the Operation element and Capabilities element it transmits in Beacon, Probe response and Association response frames. The changes may be included in all or a subset of the Capabilities and Operation elements {HT, VHT, HE, EHT, UHR, among others}. For example, the changes may not be included in the UHR Capabilities and UHR Operation elements. After providing the indication for sufficient time to ensure all associated STAs may have received it, the AP may reduce its operating parameters to the indicated values. In some embodiments, the change of operating parameters to the reduced parameters may be treated as a Critical Update and correspondingly the values of the BSS Parameter Change Count field and Critical Update flag may be changed. A STA may receive this indication from AP and communicate with AP in accordance with AP's indicated reduced capabilities. In some embodiments, after transitioning to the reduced capabilities, the AP may continue to broadcast the indication of the reduced operating parameters in the Operating element and Capabilities element included in Beacons, Probe Response or Association Response frames for the benefit of newly associated STAs.

In some embodiments, the values of the channel width, MCS and NSS set corresponding to the reduced operating parameters may be indicated in the frame transmitted by the AP to switch to DPS mode. This may be done, for example, by including the Operating Mode field of the OM Control field as part of the frame transmitted to switch to DPS mode. In some embodiments, a standard specification document may predefine one or more options for the supported channel width, MCS, NSS, PHY versions in the reduced operating state, and correspondingly the identifier for the applicable option may be indicated in the frame transmitted by the AP.

Indication of enhanced operating parameters in accordance with this disclosure is described herein. In some embodiments, the enhanced parameters to be indicated may include the enhanced maximum channel width, the channel numbers corresponding to the enhanced maximum channel width and the enhanced MCS and NSS values, among other values. In some embodiments, the maximum enhanced channel width may be indicated, for example, using an 8-bit DPS Channel Width field.

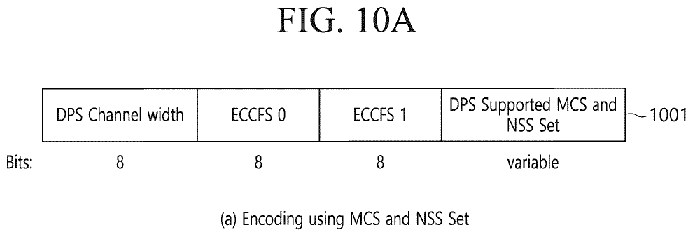

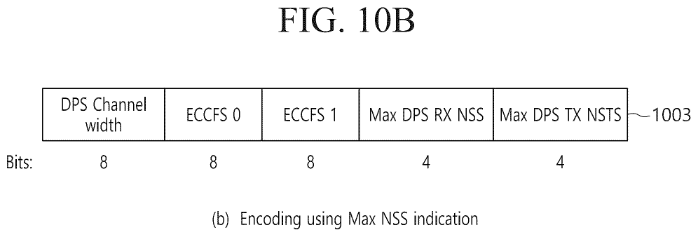

FIG. 10A and FIG. 10B illustrate example formats of Enhanced operating parameters in accordance with an embodiment. In particular, FIG. 10A illustrates an encoding using MCS and NSS set 1001 that includes a DPS Channel Width field, a ECCFS 0 field, a ECCFS 1 field, and a DPS Supported MCS and NSS Set field. FIG. 10B illustrates an encoding using an Max NSS Indication element 1003 which includes a DPS Channel Width field, an ECCFS 0 field, an ECCFS 1 field, a Max DPS RX NSS field, and a Max DPS TX NSTS field. The fields of the elements 1001 in FIG. 10A and 1003 in FIG. 10B may be similar as described herein.

The DPS Channel Width field may provide channel width information. In some embodiments, the channels corresponding to the enhanced channel width may be identified by including an 8-bit Enhanced Channel Center Frequency Segment 0 (ECCFS 0) and an 8-bit ECCFS 1 field. In some embodiments, the ECCFS 0 may indicate the channel number of the center frequency of the primary contiguous segment of the enhanced channel width. If the enhanced channel width is not contiguous, the ECCFS 1 may indicate the center frequency of the secondary contiguous segment of the enhanced channel width. This can, for example, reuse the Wide Bandwidth Channel Switch element. In some embodiments, the DPS operation may only be performed if the enhanced channel width is contiguous. In certain embodiments, there may be multiple ECCFS fields to indicate the center frequencies for each channel width larger than the reduced channel width up to the enhanced channel width. In some embodiments, the channel numbers for the channel width may be indicated by including, for example, a Supported Channels element as a subfield.

In FIG. 10A, in element 1001, the enhanced MCS and NSS values may be indicated by including an Enhanced MCS and NSS bitmap field corresponding to different supported enhanced channel widths. In FIG. 10B, in element 1003, the increased NSS may be identified using a Max DPS RX NSS field and a Max DPS TX NSTS field. In these embodiments, the supported MCS and NSS may be identified similar to Operating Mode Notification procedure.

In some embodiments, the AP may provide the indication of the enhanced operating parameters as optional fields of the UHR Operation element transmitted by the AP in Beacon, Probe Response and Association Response frames. These elements may be included in the Operation element before the enablement of DPS mode or during the operation in DPS mode by the AP. In some embodiments, the elements may not be included after DPS mode is disabled.

In some embodiments, the AP may provide the indication of the enhanced operating parameters as optional fields of the EHT or UHR Capabilities element transmitted by the AP in Beacon, Probe Response and Association Response frames. These enhanced operation parameters may be included in the Capabilities element only when the DPS mode is enabled by the AP.

In some embodiments, the enhanced parameters can be included in a new frame or element that indicates the operation in DPS mode. In some embodiments, the AP may update some of the enhanced parameters during run time, and this may be considered as a critical update.

In some embodiments, there can be multiple enhanced operating states that an AP may switch to when operating in DPS mode. The parameters, such as bandwidth and NSS, can be different for each of these operating states, and each such state can be identified by a specific state ID. Correspondingly, the aforementioned indication of the enhanced operating parameters can be indicated for each state ID of the AP in DPS mode. For example, state ID 0 can be used to represent the reduced operating parameters state.

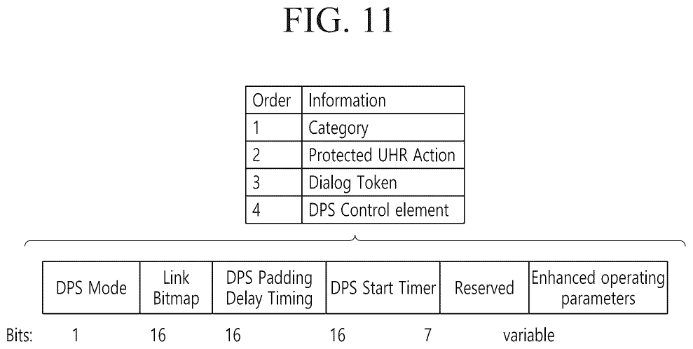

Indications of switching into or out of DPS mode in accordance with this disclosure are described herein. FIG. 11 illustrates an example of a DPS Mode Notification frame and a DPS Control element in accordance with an embodiment. The frame includes a Category field, a Protected UHR Action field, a Dialog Token field, and a DPS Control element. The DPS Control element field includes a DPS Mode field, a Link ID Bitmap field, a DPS Padding Delay Timing field, a DPS Start Timer field, a reserved field, and an Enhanced Operating Parameters field. The category field may provide category information of the frame. The protected UHR Action field may provide frame format information. The Dialog Token field may provide a token identifier of the frame. The DPS Mode field may provide an indication of whether the AP is switching into or out of the DPS mode. The Link ID Bitmap may identify the link(s), for which the DPS Mode switch is applicable. The DPS Start Timer field may identify the time when the switch into or out of DPS mode will take place. The reserved field may be reserved. The enhanced operating parameters field may provide the enhanced operating parameters information.

In some embodiments, the DPS operation may be a mode that the AP explicitly enables or disables by sending a notification to all the associated STAs. In some embodiments, in the notification sent by a UHR AP to initiate a switch into DPS mode, the notification may also indicate one or more of following items. The DPS mode field may provide an indication of whether the AP is switching into or out of the DPS mode. An indication of whether the AP is updating one or more parameters associated with DPS mode operation. A Link ID field identifying the link, or a Link ID Bitmap identifying the link(s), for which the DPS Mode switch is applicable. The time required by the AP to perform the switch from the reduced operating parameters to the enhanced operating parameters. This field may be reserved when the AP is switching out of DPS mode. The time required by the AP at the end of a TXOP to perform the switch from the enhanced operating parameters to the reduced operating parameters. This field may be reserved when the AP is switching out of DPS mode. The channels, NSS and/or MCS values corresponding to the enhanced operating parameters. This field may be reserved when the AP is switching out of DPS mode. The channels, NSS, MCS values, supported PHY versions, and transmit capabilities corresponding to the reduced operating parameters. This field may be reserved when the AP is switching out of DPS mode. A DPS Start Timer field identifying the time when the switch into or out of DPS mode will take place. This can be, for example, in units of Target Beacon Transmit Times (TBTTs). An indication of the traffic identifiers or access categories of the traffic that is transmitted in a TXOP for which a non-AP STA can request an AP to switch to the enhanced capabilities. An indication of the association identifiers of the STAs that are allowed to request the AP to switch to enhanced capabilities. An indication of the time for which the AP may operate with the enhanced operating parameters once an “enhanced-operation request” is received from an associated STA. This may be referred to herein as, for example, Retention time, Hysteresis time, or enhancedOpRequestedTimeout. The time can be, for example, in units of transmit units (TUs) or beacon intervals. An indication of the time duration for which an AP remains in the enhanced operating parameters mode after every beacon or every DTIM beacon. The time can be, for example, in units of TUs or beacon intervals and may be referred to as enhancedOpPostBeaconTimeout. An indication of the current DPS state of the AP, indicating if the AP is currently operating with the enhanced operating parameters or the reduced operating parameters. An indication of the time duration for which an AP remains in the enhanced operating parameters mode once it has indicated its DPS state as being enhanced state. The time can be, for example, in units of TUs or beacon intervals and may be referred to as enhancedOpIndicatedTimeout. An indication of the start time and periodicity of the periodic intervals where the AP will operate with enhanced operating parameters. This indication can be carried, for example, by including the broadcast Target Wake Time (bTWT) IDs of bTWT elements that identify the periodic intervals. An indication of the start time and periodicity of the periodic intervals where the AP will operate with reduced operating parameters. This indication can be carried, for example, by including the broadcast Target Wake Time (bTWT) IDs of bTWT elements that identify the periodic intervals. An indication of the different DPS states that the AP can operate in when in the DPS mode. This indication can be carried, for example, by using a bitmap, where a bit n is set to 1 to indicate that DPS State ID n is a candidate state for the DPS mode. An indication of whether the AP requires a DPS supporting TXOP initiator to provide a frame with padding delay at the end of a TXOP to enable the switch of the AP back from enhanced operating parameters to reduced operating parameters. This padding may be required only if the AP is requested to switch to the enhanced operating parameters by the TXOP initiator within the TXOP. For example, if the DPS Transition Delay is smaller than a certain duration such as a DIFS duration, padding at end of the TXOP may not be needed.

Some of the indications described herein may be reserved or absent when the AP is switching out of DPS mode. In some embodiments, the notifications can be sent in a DPS Mode Notification frame that can be sent in either an individually addressed or broadcast manner. In some embodiments, the DPS Mode Notification frame can be a variant of the Operating Mode Notification frame or the Enhanced Multi-link Operating Mode Notification frame. If the notification frame is sent as an individually addressed frame, a receiving STA may send a response Notification frame to confirm the mode switch. In some embodiments, these notifications can be included in a DPS Control element, that can be included by the AP in Beacon frames, Probe Response frames and/or Association Response frames.

In some embodiments, the indication may be carried as subfields of another element included by the AP in Beacon frames, Probe Response frames or Association response frames. In some embodiments, the indication can be carried in the UHR Operation element or Reconfiguration multi-link element. In a multi-link scenario, the element can be, for example, carried in the per-STA profile of the Basic Multi-link element transmitted by an AP MLD corresponding to the AP which is operating in DPS mode. In some embodiments, the switch to DPS mode may be considered as a critical update. In certain embodiments, where the DPS Start Timer is included, the AP may switch into or out of DPS operation after the timer counts down to 0. In some embodiments, where the DPS Start Timer is not included, the switch into DPS mode may be performed after providing the indication of the switch to the associated STAs for sufficient time. The switch out of DPS mode may be performed before providing the indication of the switch out notification. In some embodiments, the AP may continue broadcasting of the notification periodically for the duration that it is operating in DPS mode. A DPS Start Timer set to 0 may indicate that the DPS mode is currently ongoing.

In some embodiments, after receiving a request to switch to the enhanced operating parameters by a non-AP STA, the AP may switch to the enhanced operating parameters for the duration of the TXOP and may switch back to the reduced operating parameters at the end of the TXOP. In certain embodiments, the AP may remain in this enhanced operating parameters state at least for a duration of time of (e.g., enhancedOpRequestedTimeout) after the end of the TXOP. In some embodiments, the value of enhancedOpRequestedTimeout may be a predetermined fixed constant. In certain embodiments, the value can be included in the DPS Control element. Although the end of TXOP is mentioned as an example, the enhancedOpRequestedTimeout may be counted from any specific time corresponding to the TXOP. The specific point in time may be determined based on when a STA sent the request, when the AP acknowledged receiving a request, or when the AP indicated accepting the request. For example, from the reception time at the AP of the request by the non-AP STA for transitioning to the enhanced operating parameters, from the transmission time of an acknowledgement by the AP to the non-AP STA's request, among others.

In some embodiments, the AP may always switch to the enhanced operating parameters state at the end of each beacon or each DTIM beacon transmitted by it. The AP may remain in this enhanced operating parameters state at least for a duration of time of enhancedOpPostBeaconTimeout after the end of the transmission of the beacon or DTIM beacon. In some embodiments, the value of enhancedOpPostBeaconTimeout may be a predetermined fixed constant. In certain embodiments, the value can be included in the DPS Control element. Although the end of the beacon transmission is mentioned as an example, the enhancedOpPostBeaconTimeout may be counted from any specific time corresponding to the beacon transmission, e.g., from the start time of transmission of the beacon frame among other times. In some embodiments, operating with enhanced parameters may not be applicable to all beacons or DTIM beacons, and there may be an indication bit in the beacon indicating whether the AP may remain in the enhanced operating parameters after the end of the beacon for enhancedOpPostBeaconTimeout time. The bit can be carried, for example, in the DPS Control element.

In some embodiments, while operating in DPS mode, the AP may also include in the DPS Control element, a DPS State field. The field may identify if the AP's default operating parameters till the next enhancedOpIndicatedTimeout beacon intervals will be the enhanced operating parameters or not. For example, the DPS State field which can be set to 1 to indicate that the AP will by default operate with enhanced operating parameters till the next enhancedOpIndicatedTimeout beacon intervals. The field can be set to 0 otherwise. Thus, a request to increase operating parameters may not need to be sent to the AP till the next enhancedOpIndicatedTimeout beacon intervals when the DPS State field is set to 1. In some embodiments, the value of enhancedOpIndicatedTimeout can be pre-determined, for example, 1. In certain embodiments, the value of enhancedOpIndicatedTimeout may also be explicitly indicated within the DPS Control field. Accordingly, with each successive beacon, the value of enhancedOpIndicatedTimeout may not be reduced by more than 1. Although the enhancedOpIndicatedTimeout has been described using units of beacon intervals, in some embodiments, the unit can be any other unit of time, including for example TUs. Similarly, enhancedOpIndicatedTimeout may be counted from any specific time corresponding to the beacon transmission, e.g., the start time of transmission of the beacon frame, among others.

In some embodiments, the AP may also include the DPS State indication in an individually addressed frame, for example, in a new A-control field. In some embodiments, if the DPS State=1, the AP may also indicate the time duration enhancedOpIndicatedTimeout for which it will continue to operate with the enhanced operating parameters as the default parameters, in units of TUs, or beacon intervals among others. Note that this DPS State=1 indication may enable the AP to temporarily indicate a switching out of DPS mode, without the overhead of actually performing a switching out of DPS mode and back into DPS mode. In some embodiments, one or more of the Timeout values may be provided in the UHR Capabilities element along with the other DPS parameters.

In some embodiments, to provide an indication to unassociated STAs, the details of the AP operating in in DPS mode can be provided in probe response frames and association response frames transmitted by an AP. In some embodiments, the details of the AP operating in DPS operation may not be shared in the reduced neighbor reports (RNR) transmitted by other APs. In certain embodiments, the RNR elements may have a field indicating that a neighboring AP is currently operating with dynamic power save operation. The indication may be in the MLD Parameters subfield of the TBTT Information field of the RNR element, that corresponds to the AP.

Requests to switch to enhanced operating parameters by a TXOP owner in accordance with this disclosure is described herein. In some embodiments, if an associated STA wants to utilize the enhanced operating parameters of an AP operating in DPS mode for an uplink transmission, after winning the TXOP, the associated STA can transmit an initial frame that occupies the current operating channel width and complies with the NSS of the AP. The frame may also have sufficient padding to enable the AP to switch to the enhanced parameters. The initial frame may also be duplicated on the other channels which are outside of the reduced operating channel width but are part of the enhanced operating channel width of the AP. In some embodiments, the initial frame format can be a non-HT duplicate PPDU format. In certain embodiments, the STA may transmit a MU-PPDU with the RUs corresponding to these other channels being unassigned and using padding on them.

In some embodiments, the initial frame may carry a DPS Wakeup field to indicate that the STA is requesting that the AP switch to the enhanced operating parameters. In some embodiments, the field can be set to 1 to indicate that the enhanced parameters are solicited. In the case of multiple enhanced operating states being available for the DPS mode, the DPS State ID can be included in the initial frame to indicate the specific enhanced operating state to transition to. The STA may also indicate the channel width corresponding to the TXOP that it has won and the number of NSS it intends to use in the TXOP. The STA may also indicate the duration for which it is requesting the AP to remain capable of receiving frames with the enhanced operating parameters, where the duration can be longer than the end of the TXOP.

The follow-up frames within the TXOP (or within the requested duration) can be transmitted at the enhanced operating channel width, MCS, NSS and/or frame formats that can be received by the AP. In some embodiments, the DPS Wakeup field may be referred to herein as a DPS Enhanced Operation field, DPS Request field, among others.

In some embodiments, an associated STA upon winning a TXOP may directly transmit uplink frames at the enhanced operating parameters of the AP (without need for inclusion of DPS Wakeup field) if one or more of the following conditions are met. If the AP has indicated a non-zero enhancedOpRequestedTimeout time for its DPS mode, and the associated STA had successfully transmitted a frame with a DPS Wakeup field set to 1 to the AP within the preceding enhancedOpRequestedTimeout time. If the has AP indicated a non-zero enhancedOpRequestedTimeout time for its DPS mode, any associated STA had successfully transmitted a frame with a DPS Wakeup field set to 1 to the AP within the preceding enhancedOpRequestedTimeout time. If the AP had transmitted a beacon frame or a DTIM beacon frame within the preceding enhancedOpPostBeaconTimeout time. If the AP had set the DPS State field of the DPS Control field to 1 in any of the preceding enhancedOpIndicatedTimeout beacon frames. In some embodiments, only a subset of these conditions may be applicable.

In some embodiments, a non-AP STA may maintain one or more countdown timers, to account for the times indicated by the AP, including: enhancedOpRequestedTimeout, enhancedOpPostBeaconTimeout and/or enhancedOpIndicatedTimeout. The non-AP STA may reset the timer at the specific point based on the definition of the Timeout intervals. For example, the timer for enhancedOpRequestedTimeout can be reset upon receiving at the non-AP STA an acknowledgement to the request for entering enhanced operation status. In some embodiments, this request may have been sent by a second STA, whereas the non-AP STA merely monitored the requested and AP's response over the air. In some embodiments, the non-AP STA may configure an initial value of these countdown timers, as zero (or expired), before or at the time when the AP enters DPS mode. For example, when an AP indicates a start time of DPS mode, or when AP's DPS mode starts. As described herein, the non-AP STA may determine whether it needs to send to the AP a request for entering enhanced operation status, based on the status of these count-down timers. For example, if any of these timers is still non-zero, then the non-AP STA may assume that the AP is already in enhanced operation status and therefore, the STA does not send request for enhanced operation status. Instead, the STA may initiate communication with AP in accordance with Enhanced Operation Parameters. If all of the non-AP STA's countdown timers are expired (or set to zero), the non-AP STA may be required to send to AP a request to enter enhanced operation status before communicating with AP according to Enhanced Operation Parameters.

In some embodiments, if an associated STA does not intend to utilize the AP's enhanced operating parameters for an uplink transmission, after winning the TXOP, the associated STA may initiate the transmission at the reduced operating parameters of the AP without the need to include an initial frame. If an initial frame is included, the bit responsible for requesting the AP to switch to the enhanced channel width and NSS capabilities may be set to 0.

In some embodiments, it may be optional for the AP to comply with the enhanced parameter switch and the AP may indicate whether it complies in the response sent to the request frame. In some embodiments, if an AP does not intend to comply with a request to switch to enhanced parameters, it may simply not respond to the request frame. In certain embodiments, the AP may respond to the request frame and there may be an explicit indication in the response frame sent by the AP of whether it has complied with the request to switch to enhanced parameters. In some embodiments, the indication may be implicit, wherein the bandwidth and NSS for the transmitted response frame indicate whether the AP has complied with the request. For example, if the response frame bandwidth and NSS are lower than the reduced operating parameters of the AP, it may imply that the AP has not complied with the request to transition to enhanced operating parameters for the TXOP. In some embodiments, if an AP indicates in a response frame that it may not comply with a request to transition to enhanced operating parameters, it may provide sufficient padding in the response frame to enable the transmitter of the request frame to re-encapsulate the PPDUs as per the reduced operating parameters of the AP. In some embodiments, an AP may indicate, in the response frame to the request frame, the DPS state that it has switched into by including its DPS State ID. In certain embodiments, the AP may include the bandwidth and NSS capabilities of the AP after the switch in the response frame transmitted. In some embodiments, it may not be optional for the AP to comply with the enhanced parameter switch. In some embodiments, only specific STAs or specific access categories or traffic identifiers (as specified by the AP or negotiated by a non-AP STA) may be allowed to request the AP to switch to the enhanced parameters. So only if the TXOP is won by such a STA or for such an access category or traffic identifier, may the non-AP STA send such a DPS wake up request.

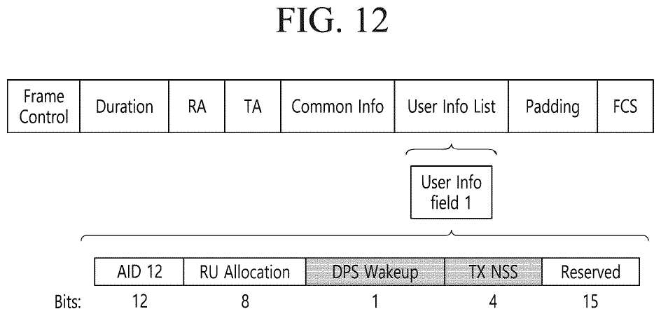

In some embodiments, the frame requesting the switch to the enhanced operating parameters can be, for example, a DPS Wakeup frame. This can be a variant of the MU-RTS trigger frame or other trigger frame, and may include a single User Info field addressed to the AP as illustrated in FIG. 12 in accordance with an embodiment. A specific value of AID12 may be used in the User Info field to indicate that the information is addressed to the AP. The frame may have the receiver address set to that of the receiving AP.

FIG. 12 illustrates a DPS Wakeup Request frame as a variant of a MU-RTS trigger frame in accordance with an embodiment. The frame may include a Frame Control field, a Duration field, a Receiver Address (RA) field, a Transmitter Address field, a User Info List field, a Padding field, a Frame Check Sequence (FCS) field. The User Info List field can include one or more user info fields from User Info field 1 to User Info field n. The User Info field can include an AID 12 field, a RU allocation field, a DPS Wakeup field, a TX NSS field, and a reserved field.

The Frame Control field provides frame control information for the frame including version, type, subtype, among other information. The Duration field provides duration information. The RA field provides the address of the recipient STA. The TA field provides the address of the transmitting STA. The Common Info field provides parameters that are common to all the addressed STAs, and includes various subfields as described below. The User Info List field provide RU allocation to one or more AIDs, and include several subfields as described below. The Padding field may provide padding information. The FCS (frame control sequence) field may provide error detection information.

The AID12 field may provide an association identifier information of the recipient of the User Info field. The RU allocation field may provide RU allocation information for the recipient of the User Info field. In some embodiments, the intended channel width of the transmission can be included in the UL BW field of the Common Info field or the RU Allocation field of the User Info field. The maximum number of spatial streams that the transmitter intends to use may be indicated in the TX NSS field of the User Info field. In certain embodiments, these indications to the AP can be carried in the Common Info field of the DPS Wakeup frame. In certain embodiments, the frame can be any frame that is transmitted at the reduced operating parameters and carries an indication that a wakeup is requested. For example, it can be a single-user or multi-user PPDU, where the bandwidth field of the SIG-A field when it is larger than the reduced channel width indicates a request to switch to the enhanced parameters. The data-subcarriers for the PPDU that lie outside of the reduced channel width may be filled with padding to keep the medium occupied till the switch is performed by the AP. In certain embodiments, an A-control field can be defined for requesting the switch to the Enhanced capabilities. The required information for the switch can be transmitted by the STA in the DPS A-control field transmitted by it.

Padding may be provided in the frame that includes the DPS Wakeup request to protect the TXOP for the time required for the AP to switch. In some embodiments, the DPS Wakeup frame may have a Pre-FCS field to help the AP to perform the Frame Check Sequence (FCS) check before switching to the enhanced parameters.

In some embodiments, when an AP is operating in DPS mode, an associated STA may transmit a request frame to the AP to request it to temporarily operate with the enhanced operating parameters up to an indicated time (while continuing to operate in DPS mode). This may be, for example, for the non-AP STA to meet some QoS requirements. This request can be part of the DPS Wakeup Request frame or the DPS Wakeup field or it can be a new Action frame transmitted by the non-AP STA. The AP may transmit a response frame to such a request frame indicating if it accepts the request.

Ensuring medium synchronization during DPS transition from enhanced to reduced capabilities in accordance with this disclosure is described herein. In some embodiments, during the transition from the enhanced operating parameters state to the reduced operating parameters state or vice versa, the AP may not be able to sense the medium state or receive traffic. When such a transition happens as a TXOP responder, it can cause loss of medium synchronization at the AP and can also cause failure of transmissions initiated by other STAs addressed to the AP.

In some embodiments, it may be ensured that during the transition from enhanced operating parameters to reduced operating parameters, the AP is capable of performing listening operation to prevent loss of medium synchronization. In some embodiments, it may be ensured that that the DPS Transition Delay for an AP is shorter than a predetermined threshold interval. This interval can be, for example, the SIFS interval or DIFS interval.

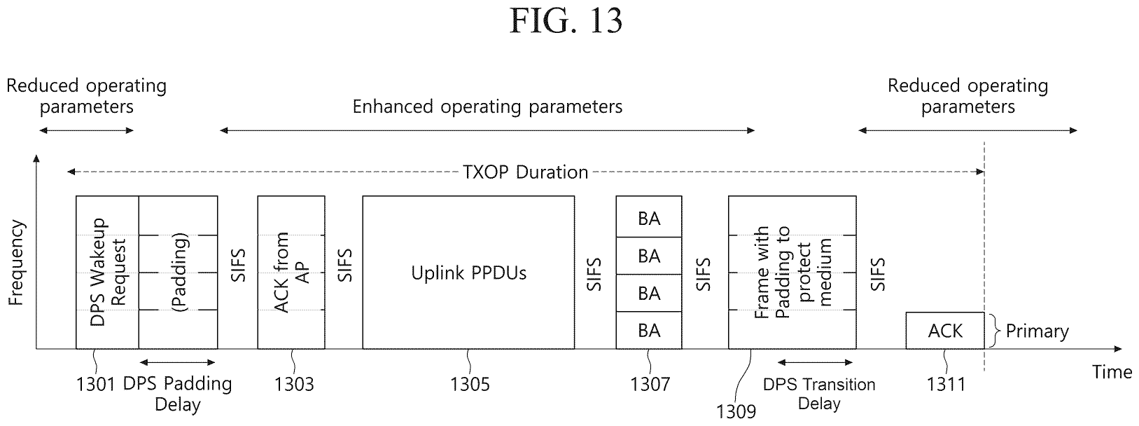

In some embodiments, when a non-AP STA initiates a transmission with an AP operating in DPS mode and the AP is expected to transition from enhanced capabilities to reduced capabilities at the end of the transmission, then the non-AP STA can end its transmission such that there is sufficient time for the AP to transmit an acknowledgement for the transmission (if required) and also transition back to reduced capabilities (DPS Transition Delay), before the end of the TXOP. In some embodiments, after receiving an acknowledgement for any frames sent to the AP, the non-AP STA may also transmit a null data packet, a new frame, or the DPS Wakeup Request frame, with sufficient MAC padding included to protect the medium for a time sufficient for the AP's transition back to the reduced capabilities (DPS Transition Delay). In some embodiments, this frame may be transmitted on the full bandwidth of the TXOP as illustrated in FIG. 13 in accordance with an embodiment.

FIG. 13 illustrates an example of protecting a medium for transition back to reduced operating parameters after uplink transmission using a follow-up frame in accordance with an embodiment. As illustrated, the STA transmits to the AP, which is operating with reduced operating parameters, a DPS wakeup request frame 1301 on the full bandwidth that includes padding for the DPS padding delay. Accordingly, the AP transitions to operating with the enhanced operating parameters. After a SIFS, the STA receives an ACK frame 1303 from the AP where the transmission occupies the full TXOP bandwidth. After a SIFS, the STA transmits to the AP uplink PPDUs 1305 to the AP occupying the full TXOP bandwidth. After a SIFS, the STA receives a BA 1307 from the AP occupying the full TXOP bandwidth. After a SIFS, the STA transmits a frame 1309 with padding to protect the medium occupying the full TXOP bandwidth, after which the AP transitions to operating with the reduced operating parameters. The STA receives an ACK frame 1311 from the AP on the primary 20 MHz bandwidth. In some embodiments, the frame with padding for medium protection may only be transmitted on the primary 20 MHz bandwidth or the reduced bandwidth of the AP (corresponding to the reduced operating parameters). After the transition to reduced capabilities, the AP may transmit an ACK frame 1311 for the null data packet, new frame, or the DPS Wakeup Request frame on the primary 20 MHz channel or at the smaller of: (i) the TXOP bandwidth and (ii) the AP's reduced operating bandwidth, or the frame may not solicit an ACK response. Note that although this procedure is shown as the last operation of the TXOP here, this may even be performed in the middle of the TXOP after completing some frame exchanges or in the beginning of the TXOP.

In some embodiments, the padding required for the transition (DPS Transition Delay) may be included in the last frame transmitted by the TXOP owner to the AP. Correspondingly, the AP may perform the transition to reduced operating parameters during the padding and the acknowledgement may be sent on only the primary 20 MHz bandwidth or may be sent on the smaller of (i) the TXOP bandwidth and (ii) the reduced bandwidth of the AP (corresponding to the reduced operating parameters).

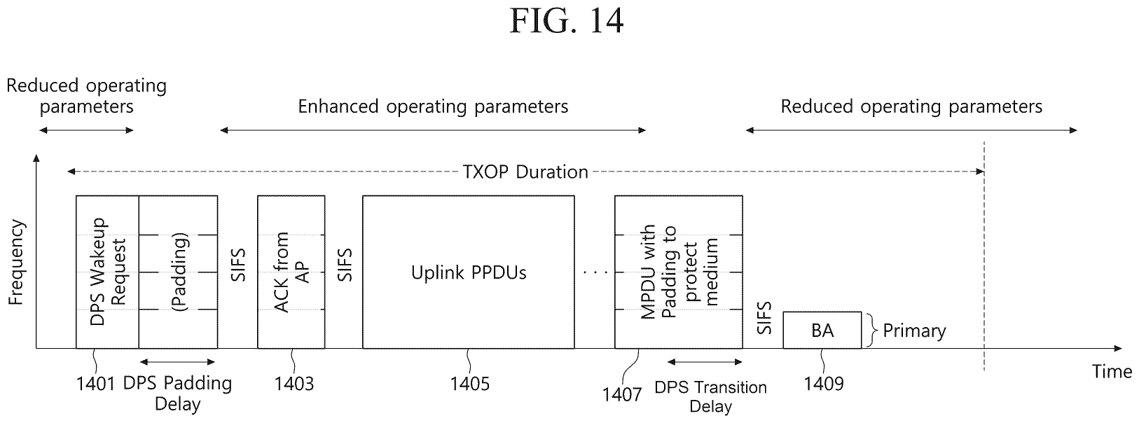

FIG. 14 illustrates an example of protecting a medium for transition back to reduced operating parameters after uplink transmission using padding in an uplink frame in accordance with an embodiment. As illustrated, the last frame can also be an aggregated MAC Protocol Data Unit (A-MPDU) 1407, and the padding can be provided by a null MPDU that is included in the A-MPDU. Although this procedure is shown as the last operation of the TXOP here, this may even be performed in the middle of a TXOP after completing some frame exchanges or in the beginning of a TXOP.

In particular, FIG. 14 illustrates the STA transmits to the AP, which is operating with reduced operating parameters, a DPS wakeup request frame 1401 on the full bandwidth that includes padding for the DPS padding delay. Accordingly, the AP transitions to operating with the enhanced operating parameters. After a SIFS, the STA receives an ACK frame 1403 from the AP occupying the full TXOP bandwidth. After a SIFS, the STA transmits to the AP uplink PPDUs 1405. In the last PPDU of the transmission, the STA transmits a MPDU frame 1407 with padding to protect the medium, after which the AP transitions to operating with the reduced operating parameters. The STA receives from the AP, a BA frame 1409 on the primary 20 MHz bandwidth.

In some embodiments, the AP may indicate within the TXOP its intention to transition to reduced parameters or remain with enhanced operating parameters at the end of the TXOP. The AP may also indicate one or more STAs that the AP requests to assist with protecting the medium while the AP transitions from the enhanced operating parameters to the reduced operating parameters. When the AP is the TXOP responder, such indications can be included in a field of the acknowledgement frame sent by the AP. This may be beneficial for the non-AP STA to determine if the AP is expected to transition to reduced capabilities in the middle or the end of the transmission and if the STA is supposed to transmit the null data packet, a new frame, or the DPS Wakeup Request frame.

In some embodiments, some DPS implementations may be able to keep the DPS Transition Delay below a threshold and thus may not require medium protection for the switch back from enhanced to reduced operating parameters. Correspondingly, the DPS AP may indicate in the DPS Notification frame, the DPS Control element, or the UHR Capabilities element, whether the AP requires medium protection for switch back, implicitly or explicitly. Correspondingly, the a forementioned medium protection mechanisms may be provided by the non-AP STA only if the AP indicates that it requires medium protection for switch back to reduced operating parameters.

Note that although the above procedures have been mentioned for the case where the AP is a TXOP responder, all, or some of them may also be applicable for the case where the AP is the TXOP initiator, and the non-AP STAs are performing triggered uplink transmissions. They may also be applicable for the case where the AP is the TXOP owner, but the TXOP has been shared with the non-AP STA via triggered TXOP sharing procedure.

DPS operation during special service periods in accordance with this disclosure is described herein. In some embodiments, at the beginning of a Restricted Target Wake Time (R-TWT) service period (SP), an AP operating in DPS mode may automatically increase its capabilities to support the enhanced operating parameters without explicitly receiving an indication to do so. In some embodiments, the STAs may not need to transmit an initial frame with sufficient padding to enable the switch to the enhanced capabilities. In certain embodiments, an AP may not follow this procedure for all R-TWTs, and the TWTs for which this is applicable may be indicated by the AP. In some embodiments, the AP may include an indication in the TWT element corresponding to the R-TWT service period whether or not the enhanced operating parameters are directly applicable for the TWT service periods. In certain embodiments, the AP may include the TWT ID for the TWT elements for which enhanced operating parameters are directly applicable in the DPS Control element or DPS Notification frame that it transmits. For all the R-TWTs that are not indicated in this way, a STA initiating transmission may still need to transmit an initial frame to solicit the enhanced operating parameters from the AP. In certain embodiments, the AP is not expected to perform the switch to enhanced operating parameters in the beginning of an R-TWT SP. Correspondingly a STA may still need to transmit an initial frame to solicit the enhanced operating parameters from the AP. In certain embodiments, the AP may indicate certain R-TWT SPs during which it will only communicate as per the reduced operating parameters. During such SPs, any STA may only initiate transmission as per the AP's reduced operating parameters. In some embodiments, the AP may include an indication in the TWT element corresponding to the R-TWT SP whether only reduced operating parameters are applicable for the TWT service periods. In certain embodiments, the AP may include the TWT ID for the TWT elements for which only reduced operating parameters are applicable in the DPS Control element or DPS Notification frame that it transmits. In some embodiments, similar rules may be applicable for the case of Individual TWT and/or broadcast TWT.

In some embodiments, the DPS operation may be limited to specific periodic SPs. Within the SPs, the AP is capable of switching to the enhanced operating parameters upon receiving an initial frame from the non-AP STA requesting the same. Outside these service periods, any non-AP STA may only communicate with the AP as per the AP's reduced operating parameters. The indication of the start time and periodicity of these periodic SPs and the duration for which the SP schedule lasts may be provided in the beacon frames or DPS Notification frames that the AP transmits. In some embodiments, the AP may include one or more broadcast TWT (B-TWT) elements within the DPS Control field to indicate the SPs where the DPS operation is applicable. In certain embodiments, the B-TWT elements may be carried outside the DPS Control field, and the element may have an indication of whether the B-TWT is used to indicate the SPs corresponds to the DPS operation of the AP. This indication may be done, for example, using a new Broadcast TWT Recommendation field value or a specific BTWT ID that is reserved for such indication, or by adding a new field to the BTWT element. In certain embodiments, the rules for transmission outside the SPs may be flexible. In other words, outside of the SPs a non-AP STA may still initiate transmissions with an initial control frame to the AP requesting to switch to enhanced operating parameters, but the AP may reject the request with a higher likelihood than within the SPs.

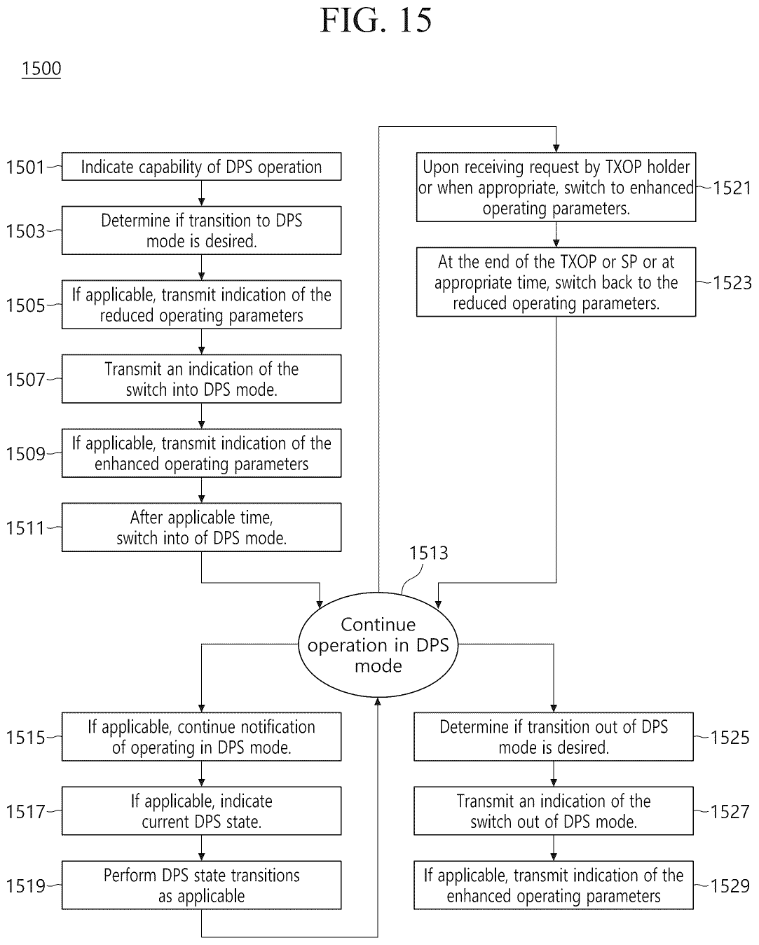

FIG. 15 illustrates a flow chart of an example process performed by an AP for DPS operation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 15 illustrates operations performed in an AP, such as the AP illustrated in FIG. 3.

The process 1500, in operation 1501, the AP indicates a capability of DPS operation. In some embodiments, the AP may indicate if it supports operating in DPS mode, by setting a capability bit to 1 in an element that it transmits in Beacon, Probe Response and/or Association Response frames. Otherwise, the bit may be set to 0.

In operation 1503, the AP determines if a transition to DPS mode is desired.

In operation 1505, the AP transmits to one or more STAs, if applicable, indication of the reduced operating parameters.

In operation 1507, the AP transmits an indication of the switch into DPS mode. In some embodiments, at least before switching to DPS mode, the AP may indicate Reduced Operating Parameters applied during DPS mode operation, e.g., one or more of reduced channel width, restricted PPDU formats, MCS set and NSS, applied to reception, transmission or both. In some embodiments, the AP may provide the indication of the reduced operating parameters before switching to DPS mode using existing mechanisms.

In operation 1509, the AP transmits, if applicable, indication of the enhanced operating parameters. In some embodiments, the enhanced parameters to be indicated may include the enhanced maximum channel width, the channel numbers corresponding to the enhanced maximum channel width and the enhanced MCS and NSS values, among other values. In some embodiments, the maximum enhanced channel width may be indicated, for example, using a 8-bit DPS Channel Width field.

In operation 1511, the AP switches, after an applicable time, into DPS mode.

In operation 1513, the AP continues operation in DPS mode. In some embodiments, while operating in DPS mode, the AP may also include in the DPS Control element, a DPS State field. The field may identify if the AP's default operating parameters till the next enhancedOpIndicatedTimeout beacon intervals will be the enhanced operating parameters or not.

In operation 1515, the AP continues, if applicable, notification of operating in DPS mode.

In operation 1517, the AP indicates, if applicable, current DPS state. The AP may provide an indication of the different DPS states that the AP can operate in when in the DPS mode. This indication can be carried, for example, by using a bitmap, where a bit n is set to 1 to indicate that DPS State ID n is a candidate state for the DPS mode.

In operation 1519, the AP performs DPS state transition as applicable and proceeds to operation 1513 where the AP continues operation the DPS mode.

In operation 1521, the AP, upon receiving a request from a TXOP holder or when appropriate, switches to enhanced operating parameters. In certain embodiments, the AP may remain in this enhanced operating parameters state at least for a duration of time of (e.g., enhancedOpRequestedTimeout) after the end of the TXOP. In some embodiments, the value of enhancedOpRequestedTimeout may be a predetermined fixed constant. In certain embodiments, the value can be included in the DPS Control element.

In operation 1523, the AP, at the end of the TXOP or service period (SP) or at an appropriate time, switches back to the reduced operating parameters and proceeds to operation 1513 where the AP continues operation in DPS mode.

In operation 1525, the AP determines if a transition out of DPS mode is desired.

In operation 1527, the AP transmits an indication of the switch out of DPS mode.

In operation 1529, the AP transmits, if applicable, an indication of the enhanced operating parameters.

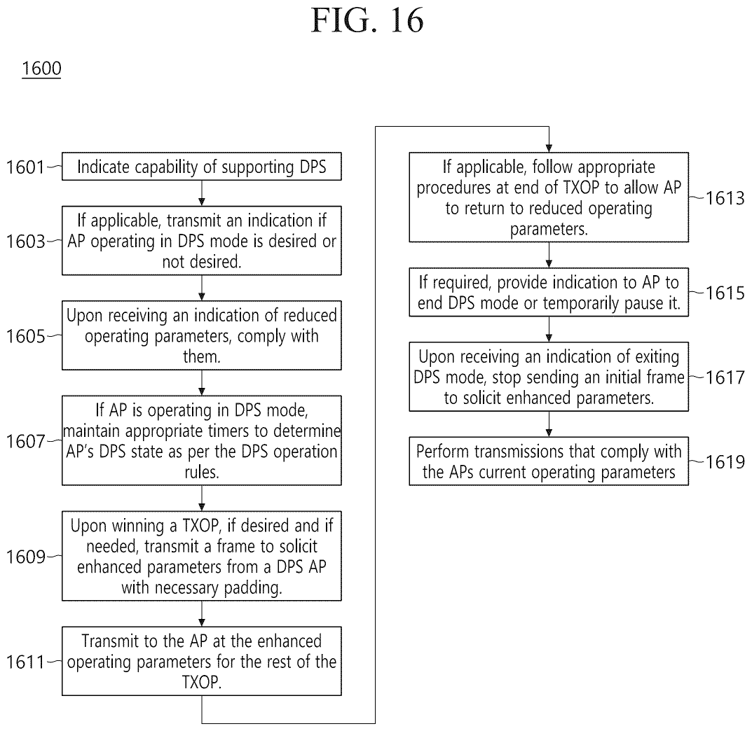

FIG. 16 illustrates a flow chart of an example process performed by a non-AP STA to support an AP operating in DPS mode in accordance with an embodiment. Although one or more operations are described or shown in particular sequential order, in other embodiments the operations may be rearranged in a different order, which may include performance of multiple operations in at least partially overlapping time periods. The flowchart depicted in FIG. 16 illustrates operations performed in an STA, such as the STA illustrated in FIG. 3.

The process 1600, in operation 1601, the STA indicates to an AP a capability of supporting DPS. In some embodiments, a non-AP STA can indicate if it is capable of sending a request frame to an AP operating in DPS to transition to the enhanced capabilities. In some embodiments, the STA may set a capability bit to 1 in an element that it transmits in Probe Request and/or Association Request frames to indicate to the AP that it is capable of sending a request frame to the AP to transition to enhanced capabilities. Otherwise, the bit may be set to 0. In some embodiments, the indication can be carried in the UHR Capabilities element. The bit can be, for example, the same as the DPS Support subfield. In some embodiments, the DPS Support subfield may be reserved for a non-AP STA. In certain embodiments that involve multi-link operation, the DPS Support may be common for all the STAs associated with an MLD and correspondingly the DPS support parameters may be indicated in the Common Info field of the Basic Multi-link element transmitted by the MLD

In operation 1603, the STA transmits, if applicable, an indication if AP operating in DPS mode is desired or not.

In operation 1605, the STA, upon receiving an indication of the AP operating with reduced operating parameters, complies with the reduced operating parameters.

In operation 1607, the STA, upon winning a TXOP, if desired and if needed, transmits a frame to solicit enhanced parameters from the AP with necessary padding. In some embodiments, if an associated STA wants to utilize the enhanced operating parameters of an AP operating in DPS mode for an uplink transmission, after winning the TXOP, the associated STA can transmit an initial frame that occupies the current operating channel width and complies with the NSS of the AP. The frame may also have sufficient padding to enable the AP to switch to the enhanced parameters.

In operation 1611, the STA transmits to the AP at the enhanced operating parameters for the rest of the TXOP. The follow-up frames within the TXOP (or within the requested duration) can be transmitted at the enhanced operating channel width, MCS, NSS and/or frame formats that can be received by the AP.

In operation 1613, the STA, if applicable, performs appropriate follow up procedures at the end of the TXOP to allow the AP to return to reduced operating parameters.

In operation 1615, the STA provides, if required, an indication to the AP to end DPS mode or temporarily pause it.

In operation 1617, the STA, upon receiving an indication of exiting DPS mode from the AP, stops sending an initial frame to solicit the enhanced parameters.

In operation 1619, the STA performs transmission that comply with the AP's current operating parameters.

In some embodiments, a non-AP STA may use the DPS mode to save power. In some embodiments, the non-AP STA transmits a capability bit to indicate that it is capable of operating in DPS mode and the AP transmits a capability bit to indicate that it is capable of sending an initial control frame to help a DPS STA transition from reduced capability state to enhanced capability state. To turn on the DPS mode, the non-AP STA may transmit to the AP a frame that includes the DPS Mode switch. The operation may be similar to single-link EMLSR operation, and thus an EML Operating Mode Notification frame can be used for an indication of the switch to DPS mode. An additional bit can be added to the frame to indicate that the frame is for enabling or disabling the DPS mode at the non-AP STA. An additional bit may also be present to indicate that the frame is to update one or more parameters associated with operation in DPS mode. Correspondingly, in some embodiments, if an AP intends to request the DPS non-AP STA to switch to enhanced capabilities, in a TXOP the AP may transmit a DPS wakeup request frame or a frame that includes a DPS Wakeup A-control field. This frame may be sent at some predefined base data rate at a base MCS with a single spatial stream and at a base channel width. For example, it can be non-HT duplicate PPDU sent at 6 Mbps.

In some embodiments, the non-AP may indicate the channel width, MCS and NSS it supports before the switch to enhanced capabilities in the frame sent to initiate the DPS mode. The AP may correspondingly send the DPS Wakeup Request frame that complies with these indicated reduced capabilities. An AP may also choose to not request the non-AP STA to switch to enhanced operating parameters by not sending a DPS wakeup request frame.

Embodiments in accordance with this disclosure provide for reducing operating parameters of an AP MLD to save power, using processes that may be compatible with legacy devices. Furthermore, an AP may quickly scale back to its full operating parameters within a transmit opportunity on demand from a STA to meet the operating requirements of the STA, including channel width, number of spatial streams, among others.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, comprising:
a memory; and
a processor coupled to the memory, the processor configured to:
transmit, to one or more stations (STAs), a first frame indicating that the AP supports an operation in a dynamic power saving mode;
transmit, to the one or more STAs, a second frame indicating a transition into the dynamic power saving mode;
operate in the dynamic power save mode and follow associated procedures; and
transmit, to the one or more STAs, a third frame indicating a transition out of the dynamic power saving mode.

2. The AP of claim 1, wherein the first frame includes at least one of: i) a maximum time that the AP requires to switch from a reduced operating parameter set to an enhanced operating parameter set associated with dynamic power saving mode, ii) a maximum time that the AP requires to switch from the enhanced operating parameter set to the reduced operating parameter set associated with dynamic power saving mode, or iii) an indication of whether the AP requires medium protection while the AP transitions from the enhanced operating parameter set to the reduced operating parameter set associated with dynamic power saving mode.

3. The AP of claim 1, wherein the second frame includes at least one of:
an indication of the AP transition into the dynamic power saving mode;
an indication of a start time for the transition to the dynamic power saving mode;
an indication of a reduced operating parameter set associated with the dynamic power saving mode;
an indication of one or more enhanced operating parameter sets associated with the dynamic power saving mode;
an indication of a maximum time that the AP requires to switch from the reduced operating parameter set to the one or more enhanced operating parameter sets associated with dynamic power saving mode;
an indication of a maximum time that the AP requires to switch from the one or more enhanced operating parameter sets to the reduced operating parameter set associated with dynamic power saving mode; or an indication of whether the AP requires medium protection while the AP transitions from the one or more enhanced operating parameter sets to the reduced operating parameter set associated with dynamic power saving mode.

4. The AP of claim 1, wherein the AP operates with a reduced operating parameter set in the dynamic power saving mode by default, where the reduced operating parameter set includes a reduction of at least one of a maximum supported channel width, a supported set of modulation and coding schemes, a maximum supported number of spatial streams, or supported physical layer version formats for either transmission or reception at the AP.

5. The AP of claim 1, wherein the processor is further configured to:
receive, from at least one STA in the one or more STAs, a fourth frame that requests a transition to an enhanced operating parameter set; and
transition to the enhanced operating parameter set, wherein the enhanced operating parameter set includes at least one of an enhanced maximum supported channel width, channel numbers corresponding to the enhanced maximum channel width, enhanced set of modulation and coding schemes, an increased maximum supported number of spatial streams, or an increased set of supported physical layer version formats.

6. The AP of claim 5, wherein the processor is further configured to operate with the enhanced operating parameter set associated with the dynamic power save mode for a duration of a transmission opportunity (TXOP) corresponding to the fourth frame, and switch back to a reduced operating parameter set associated with the dynamic power saving mode at a time determined by the end of the TXOP.

7. The AP of claim 1, wherein the processor is further configured to periodically transmit a fifth frame indicating dynamic power saving parameters including one or more of:
an indication of the AP operating in the dynamic power saving mode;
an indication of one or more enhanced operating parameter sets associated with the dynamic power saving mode;
an indication of a reduced operating parameter set associated with the dynamic power saving mode; or
an indication of the AP operating with the one or more enhanced operating parameter sets for a given duration after the indication.

8. The AP of claim 1, wherein the processor is further configured to transmit, before operating in the dynamic power saving mode, a sixth frame to the one or more STAs that indicates a change in the AP's transmission and reception capabilities, where the capabilities are determined based on a reduced operating parameter set associated with the dynamic power saving mode.

9. The AP of claim 1, wherein the processor is further configured to:
receive, from at least one STA in the one or more STAs, a seventh frame that indicates a capability of sending a request frame to the AP to transition to an enhanced operating parameter set associated with the dynamic power saving mode.

10. The AP of claim 1, wherein the third frame includes at least one of:
an indication that the AP is transitioning out of the dynamic power saving mode; or
an indication of a time when the AP transitions out of the dynamic power saving mode.

11. A station (STA) in a wireless network, comprising:
a memory; and
a processor coupled to the memory, the processor configured to:
receive, from an access point (AP), a first frame indicating that the AP supports an operation in a dynamic power saving mode;
receive, from the AP, a second frame indicating a transition into or out of the dynamic power saving mode; and
while the AP is operating in dynamic power save mode, follow associated procedures.

12. The STA of claim 11, wherein the first frame includes at least one of: i) a maximum time that the AP requires to switch from a reduced operating parameter set to an enhanced operating parameter set associated with the dynamic power saving mode, ii) a maximum time that the AP requires to switch from the enhanced operating parameter set to the reduced operating parameter set associated with the dynamic power saving mode, or iii) an indication of whether the AP requires medium protection while the AP transitions from the enhanced operating parameter set to the reduced operating parameter set associated with the dynamic power saving mode.

13. The STA of claim 11, wherein the second frame includes at least one of:
an indication of the AP transition into the dynamic power saving mode;
an indication of a start time for the transition to the dynamic power saving mode;
an indication of a reduced operating parameter set associated with the dynamic power saving mode;
an indication of one or more enhanced operating parameter sets associated with the dynamic power saving mode;
an indication of a maximum time that the AP requires to switch from the reduced operating parameter set to the one or more enhanced operating parameter sets associated with dynamic power saving mode;
an indication of a maximum time that the AP requires to switch from the one or more enhanced operating parameter sets to the reduced operating parameter set associated with dynamic power saving mode; or
an indication of whether the AP requires medium protection while the AP transitions from the one or more enhanced operating parameter sets to the reduced operating parameter set associated with dynamic power saving mode.

14. The STA of claim 11, wherein the AP operates with a reduced operating parameter set in the dynamic power saving mode by default, wherein the reduced operating parameter set includes a reduction of at least one of a maximum supported channel width, a supported modulation coding schemes, a maximum supported number of spatial streams, or supported physical layer version formats for either transmission or reception at the AP.

15. The STA of claim 11, wherein the AP operates with one or more enhanced operating parameter sets, wherein the one or more enhanced operating parameter sets includes at least one of an enhanced maximum channel width, channel numbers corresponding to the enhanced maximum supported channel width, enhanced set of modulation and coding schemes, an increased maximum supported number of spatial streams, or an increased set of supported physical layer version formats.

16. The STA of claim 11, wherein after winning a transmit opportunity, the processor is configured to determine if the AP is operating with either an enhanced operating parameter set or a reduced operating parameter set and based on the determination, either:
transmit to the AP frames that are compliant with the enhanced operating parameter set of the AP, or
transmit to the AP frames that are compliant with the reduced operating parameter set of the AP, or
transmit to the AP a third frame that requests the AP to transition to an enhanced operating parameter set and transmit subsequent frames that are compliant with the enhanced operating parameter set for the duration of the transmit opportunity.

17. The STA of claim 11, wherein the processor is further configured to:
transmit, to the AP, a fourth frame that indicates a capability of sending a request frame to the AP to transition to an enhanced operating parameter set associated with the dynamic power saving mode.

18. A computer-implemented method for wireless communication by an access point (AP) in a wireless network, comprising:
transmitting, to one or more stations (STAs), a first frame indicating that the AP supports an operation in a dynamic power saving mode;
transmitting, to the one or more STAs, a second frame indicating a transition into the dynamic power saving mode;
operating in the dynamic power save mode and follow associated procedures; and
transmitting, to the one or more STAs, a third frame indicating a transition out of the dynamic power saving mode.

19. The computer-implemented method of claim 18, wherein the first frame includes at least one of: i) a maximum time that the AP requires to switch from a reduced operating parameter set to an enhanced operating parameter set associated with dynamic power saving mode, ii) a maximum time that the AP requires to switch from the enhanced operating parameter set to the reduced operating parameter set associated with dynamic power saving mode, or iii) an indication of whether the AP requires medium protection while the AP transitions from the enhanced operating parameter set to the reduced operating parameter set associated with dynamic power saving mode.

20. The computer-implemented method of claim 18, wherein the second frame includes at least one of:
an indication of the AP transition into the dynamic power saving mode;
an indication of a start time for the transition to the dynamic power saving mode;
an indication of a reduced operating parameter set associated with the dynamic power saving mode;
an indication of one or more enhanced operating parameter sets associated with the dynamic power saving mode;
an indication of a maximum time that the AP requires to switch from the reduced operating parameter set to the one or more enhanced operating parameter sets associated with dynamic power saving mode;
an indication of a maximum time that the AP requires to switch from the one or more enhanced operating parameter sets to the reduced operating parameter set associated with dynamic power saving mode; or
an indication of whether the AP requires medium protection while the AP transitions from the one or more enhanced operating parameter sets to the reduced operating parameter set associated with dynamic power saving mode.
